(19) United States
(12) Patent Application Publication
(10) Pub. No.: US 2025/0012605 A1
(43) Pub. Date: Jan. 9, 2025

(54) DISPLACEMENT DETECTION DEVICE, DISPLACEMENT DETECTION SYSTEM AND INDUSTRIAL EQUIPMENT

(71) Applicant: NHK SPRING CO., LTD., Yokohama-shi (JP)

(72) Inventors: Shinji IINO, Yokohama-shi (JP); Saiji UETSUHARA, Yokohama-shi (JP); Takuya SATO, Yokohama-shi (JP)

(21) Appl. No.: 18/891,702

(22) Filed: Sep. 20, 2024

Related U.S. Application Data
(63) Continuation of application No. PCT/JP2023/000799, filed on Jan. 13, 2023.

(30) Foreign Application Priority Data
Mar. 28, 2022 (JP) 2022-052421

(51) Int. Cl. G01D 5/14; B60G 15/06; B60G 17/019; B60G 17/08; G01B 7/30; G01D 5/16

(52) U.S. Cl. CPC G01D 5/145; B60G 15/063; G01B 7/30; G01D 5/16; B60G 17/019; B60G 17/08; B60G 2202/312; B60G 2204/418; B60G 2204/62; B60G 2400/25; B60G 2401/172; B60G 2401/26

(57) ABSTRACT

A displacement detection device includes a first fixed member, a coil spring including a first end turn portion and a second end turn portion, a rotating member in contact with the first end turn portion, a second fixed member in contact with the second end turn portion, and a detection device capable of detecting an amount of rotation of the coil spring. The rotating member is rotatably supported using a bearing, and the bearing is in contact with the first fixed member and the rotating member.

### CROSS-REFERENCE TO RELATED APPLICATIONS

This application is a Continuation of International Patent Application No. PCT/JP2023/000799, filed on Jan. 13, 2023, which claims the benefit of priority to Japanese Patent Application No. 2022-052421, filed on Mar. 28, 2022, the entire contents of which are incorporated herein by reference.

### FIELD

An embodiment of the present invention relates to a displacement detection device, a displacement detection system and industrial equipment.

### BACKGROUND

In general industrial equipment including vehicles such as automobiles, motorcycles, and railway vehicles, a device for detecting a height of industrial equipment from the ground or a height of the industrial equipment from a reference position (hereinafter referred to as a displacement detection device) is used. For example, in a vehicle, automatic optical axis adjustment of a headlamp can be performed by detecting a vehicle height using a displacement detection device.

In a vehicle, the displacement detection device includes, for example, a suspension or a detection device (sensor) arranged between the suspension and the vehicle body. Examples of the method for detecting the vehicle height include a method for detecting displacement of the suspension using the sensor, and a method for detecting an amount of strain caused by a load applied to the suspension using the sensor (Japanese Laid-Open Patent Publication No. 2010-085215).

### SUMMARY

A displacement detection device according to an embodiment of the present invention includes a first fixed member, a coil spring including a first end turn portion and a second end turn portion, a rotating member in contact with the first end turn portion, a second fixed member in contact with the second end turn portion, and a detection device capable of detecting an amount of rotation of the coil spring.

The rotating member may be rotatably supported using a bearing, and the bearing may be in contact with the first fixed member and the rotating member.

The detection device may be disposed on a side opposite to a side on which the rotating member is disposed with respect to the first fixed member.

The detection device may be disposed on the same side as the side on which the rotating member is disposed with respect to the first fixed member.

The detection device, the bearing, and the rotating member may be integrated.

The displacement detection device may further include a damper having a third end and a fourth end, wherein the third end is inserted into the first fixed member, the fourth end is inserted into the second fixed member, and a part of a periphery of the damper is fixed to the second fixed member.

The first fixed member and the second fixed member may have members configured using one or more of metal, plastic, or an elastic member.

In the case where the first fixed member includes the elastic member, the detection device may be covered by the elastic member.

A displacement detection system according to an embodiment of the present invention includes the displacement detection device and an arithmetic circuit connected to the detection device and configured to be able to calculate a stroke of the coil spring using the amount of rotation.

In the displacement detection system, the arithmetic circuit may include a memory circuit, and the memory circuit may include a table in which the amount of rotation is linked with the stroke.

Industrial equipment according to an embodiment of the present invention may include the displacement detection device, a machine body in contact with the first fixed member, and a wheel in contact with the second fixed member.

The industrial equipment may be a vehicle, and the machine body may be a vehicle body.

According to an embodiment of the present invention, it is possible to provide a displacement detection device, a displacement detection system, and industrial equipment having a lightweight and simple configuration with a small number of components and excellent long-term reliability.

### BRIEF DESCRIPTION OF DRAWINGS

FIG. 1A is a schematic side view of a displacement detection device according to a first embodiment of the present invention.

FIG. 1B is a schematic side view of the displacement detection device according to the first embodiment of the present invention.

FIG. 2A is an enlarged view of a first fixed member shown in FIG. 1A and FIG. 1B.

FIG. 2B is a plan view of the first fixed member shown in FIG. 2A viewed from below.

FIG. 2C is an enlarged view of a bearing shown in FIG. 1A and FIG. 1B.

FIG. 2D is a plan view showing the bearing shown in FIG. 2C viewed from below.

FIG. 2E is an enlarged view of the detection device shown in FIG. 1A and FIG. 1B.

FIG. 2F is a plan view of a detection device shown in FIG. 2E viewed from below.

FIG. 3A is an enlarged view of a rotating member shown in FIG. 1A and FIG. 1B.

FIG. 3B is a plan view of the rotating member shown in FIG. 3A viewed from below.

FIG. 3C is an enlarged view of a coil spring shown in FIG. 1A and FIG. 1B.

FIG. 3D is a plan view of the coil spring shown in FIG. 3C viewed from above.

FIG. 3E is an enlarged view of a second fixed member shown in FIG. 1A and FIG. 1B.

FIG. 3F is a plan view of the second fixed member shown in FIG. 3E viewed from above.

FIG. 4A is a schematic side view of a displacement detection device according to a second embodiment of the present invention.

FIG. 4B is a schematic side view of the displacement detection device according to the second embodiment of the present invention.

FIG. 5A is an enlarged view of the detection device shown in FIG. 4A and FIG. 4B.

FIG. 5B is a plan view of the detection device shown in FIG. 5A viewed from below.

FIG. 5C is an enlarged view of a first fixed member shown in FIG. 4A and FIG. 4B.

FIG. 5D is a plan view of the first fixed member shown in FIG. 5C viewed from below.

FIG. 5E is an enlarged view of a bearing shown in FIG. 4A and FIG. 4B.

FIG. 5F is a plan view showing the bearing shown in FIG. 5E viewed from below.

FIG. 5G is an enlarged view of a rotating member shown in FIG. 4A and FIG. 4B.

FIG. 5H is a plan view of the rotating member shown in FIG. 5G viewed from below.

FIG. 6A is a schematic side view of a displacement detection device according to a third embodiment of the present invention.

FIG. 6B is a schematic side view of the displacement detection device according to the third embodiment of the present invention.

FIG. 7A is a block diagram showing an example of a displacement detection system according to a fourth embodiment of the present invention.

FIG. 7B is a graph showing a relationship between a rotational angle of a rotating member and a stroke of a coil spring.

FIG. 8 is a diagram showing an application example of a displacement detection system according to a fifth embodiment of the present invention.

FIG. 9 is a diagram showing an application example of the displacement detection system according to the fifth embodiment of the present invention.

FIG. 10 is a front view of a portion of the application shown in FIG. 9.

FIG. 11 is a flowchart showing an operation method of the displacement detection system according to the fifth embodiment of the present invention.

FIG. 12A is a side view showing an example of an arrangement of each element in a detection device according to a sixth embodiment of the present invention.

FIG. 12B is a side view showing an example of an arrangement of each element in the detection device according to the sixth embodiment of the present invention.

FIG. 12C is an enlarged view of a first fixed member and a bearing shown in FIG. 12A and FIG. 12B.

FIG. 12D is a plan view showing the first fixed member and the bearing shown in FIG. 12C viewed from below.

FIG. 12E is an enlarged view of the detection device shown in FIG. 12A and FIG. 12B.

FIG. 12F is a plan view of the detection device shown in FIG. 12E viewed from below.

FIG. 12G is an enlarged view of a rotating member shown in FIG. 12A and FIG. 12B.

FIG. 12H is a plan view of the rotating member shown in FIG. 12G viewed from above.

FIG. 13A is a side view showing an example of an arrangement of each element in a detection device according to a seventh embodiment of the present invention.

FIG. 13B is a side view showing an example of an arrangement of each element in the detection device according to the seventh embodiment of the present invention.

FIG. 13C is an enlarged view of a first fixed member shown in FIG. 13A and FIG. 13B.

FIG. 13D is a plan view of the first fixed member shown in FIG. 13C viewed from below.

FIG. 13E is an enlarged view of a detection device shown in FIG. 13A and FIG. 13B.

FIG. 13F is a plan view of the detection device shown in FIG. 13E viewed from above.

FIG. 13G is an enlarged view of a rotating member shown in FIG. 13A and FIG. 13B.

FIG. 13H is a plan view of the rotating member shown in FIG. 13G viewed from above.

FIG. 13I is a cross-sectional view of the first fixed member, the rotating member, a bearing, and the detection device in an enlarged view of the displacement detection device shown in FIGS. 13A and 13B.

FIG. 14A is a side view showing an example of an arrangement of each element in a displacement detection device according to an eighth embodiment of the present invention.

FIG. 14B is a side view showing an example of an arrangement of each element in the displacement detection device according to the eighth embodiment of the present invention.

FIG. 14C is an enlarged view of a first fixed member and a bearing shown in FIG. 14A and FIG. 14B.

FIG. 14D is a plan view of the first fixed member shown FIG. 14C viewed from below.

FIG. 14E is an enlarged view of a detection device shown in FIG. 14A and FIG. 14B.

FIG. 14F is a plan view of a detection device shown in FIG. 14E viewed from below.

FIG. 14G is an enlarged view of a rotating member shown in FIG. 14A and FIG. 14B.

FIG. 14H is a plan view of the rotating member shown in FIG. 14G viewed from below.

FIG. 15A is a side view showing an example of an arrangement of each element in a displacement detection device according to a ninth embodiment of the present invention.

FIG. 15B is a side view showing an example of an arrangement of each element in the displacement detection device according to the ninth embodiment of the present invention.

FIG. 15C is an enlarged view of a first fixed member and a bearing shown in FIG. 15A and FIG. 15B.

FIG. 15D is a plan view of a first fixed member shown FIG. 15C viewed from below.

FIG. 15E is an enlarged view of a rotating member shown in FIG. 15A and FIG. 15B.

FIG. 15F is a plan view of the rotating member shown in FIG. 15E viewed from above.

FIG. 15G and FIG. 15H are plan views for describing a method for detecting displacement using the displacement detection device according to the ninth embodiment.

FIG. 16A is a side view showing an example of an arrangement of each element in a displacement detection device according to a tenth embodiment of the present invention.

FIG. 16B is a side view showing an example of an arrangement of each element in the displacement detection device according to the tenth embodiment of the present invention.

FIG. 16C is an enlarged view of a first fixed member and a bearing shown in FIG. 16A and FIG. 16B.

FIG. 16D is a plan view of the first fixed member shown in FIG. 16C viewed from below.

FIG. 16E is an enlarged view of a rotating member shown in FIG. 16A and FIG. 16B.

FIG. 16F is a plan view of the rotating member shown in FIG. 16E viewed from above.

FIG. 16G and FIG. 16H are plan views for describing a method for detecting displacement using the displacement detection device according to the tenth embodiment.

FIG. 17A is a side view showing an example of an arrangement of each element in a displacement detection device according to an eleventh embodiment of the present invention.

FIG. 17B is a side view showing an example of an arrangement of each element in the displacement detection device according to the eleventh embodiment of the present invention.

FIG. 17C is an enlarged view of a detection device shown in FIG. 17A and FIG. 17B.

FIG. 17D is a plan view of the detection device shown in FIG. 17C viewed from above.

FIG. 17E is an enlarged view of a rotating member shown in FIG. 17A and FIG. 17B.

FIG. 17F is a plan view of the rotating member shown in FIG. 17E viewed from above.

FIG. 17G is a cross-sectional view of the detection device, a bearing, and the rotating member in an enlarged view of the displacement detection device shown in FIG. 17A and FIG. 17B.

FIG. 18A is a side view showing an example of an arrangement of each element in a displacement detection device according to a twelfth embodiment of the present invention.

FIG. 18B is a side view showing an example of an arrangement of each element in the displacement detection device according to the twelfth embodiment of the present invention.

FIG. 18C is an enlarged view of a detection device, a first fixed member, and a bearing shown in FIG. 18A and FIG. 18B.

FIG. 18D is a plan view of the first fixed member shown in FIG. 18C viewed from above.

FIG. 18E is a cross-sectional view of the detection device, the first fixed member, the bearing, and a rotating member in an enlarged view of the displacement detection device shown in FIG. 18A and FIG. 18B.

FIG. 18F is a side view for describing a method for detecting displacement using the displacement detection device according to the twelfth embodiment.

FIG. 19A is a side view showing an example of an arrangement of each element in a displacement detection device according to a thirteenth embodiment of the present invention.

FIG. 19B is a side view showing an example of an arrangement of each element in the displacement detection device according to the thirteenth embodiment of the present invention.

FIG. 19C is an enlarged view of a first fixed member shown in FIG. 19A and FIG. 19B.

FIG. 19D is a plan view of the first fixed member shown in FIG. 19D viewed from below.

FIG. 19E is an enlarged view of a rotating member shown in FIG. 19A and FIG. 19B.

FIG. 19F is a plan view of the rotating member shown in FIG. 19E viewed from above.

FIG. 19G is a cross-sectional view of a detection device, a bearing, and the rotating member in an enlarged view of the displacement detection device shown in FIG. 19A and FIG. 19B.

FIG. 20A is a side view showing an example of an arrangement of each element in a displacement detection device according to a fourteenth embodiment of the present invention.

FIG. 20B is a side view showing an example of an arrangement of each element in the displacement detection device according to the fourteenth embodiment of the present invention.

FIG. 20C is an enlarged view of a rotating member shown in FIG. 20A and FIG. 20B.

FIG. 20D is a plan view of the rotating member shown in FIG. 20C viewed from below.

FIG. 20E is a schematic diagram for describing a method for detecting displacement using the displacement detection device according to the fourteenth embodiment.

FIG. 21A is a side view showing an example of an arrangement of each element in a displacement detection device according to a fifteenth embodiment of the present invention.

FIG. 21B is a side view showing an example of an arrangement of each element in the displacement detection device according to the fifteenth embodiment of the present invention.

FIG. 21C is an enlarged view of a first fixed member and a bearing shown in FIG. 21A and FIG. 21B.

FIG. 21D is a plan view of the first fixed member shown in FIG. 21C viewed from below.

FIG. 21E is an enlarged view of a rotating member shown in FIG. 21A and FIG. 21B.

FIG. 21F is a plan view of the rotating member shown in FIG. 21E viewed from above.

FIG. 21G and FIG. 21H are a graph and a schematic diagram for describing a method for detecting displacement using the displacement detection device according to the fifteenth embodiment.

### DESCRIPTION OF EMBODIMENTS

Hereinafter, embodiments of the present invention will be described with reference to the drawings. However, the present invention can be implemented in various forms without departing from the gist thereof, and is not to be construed as being limited to the description of the embodiments exemplified below.

In the drawings, although the widths, thicknesses, shapes, and the like of the respective portions may be schematically represented in comparison with the actual embodiments for clarity of explanation, the drawings are merely examples, and do not limit the interpretation of the present invention. In addition, in the embodiments of the present invention, elements having the same functions as those described with respect to the drawings already shown are denoted by the same reference signs, and redundant descriptions thereof may be omitted.

In each embodiments of the present invention, in the case where a plurality of the same or similar configurations are collectively represented, the configurations may be described by the same reference signs or the same reference signs plus capital letters. In the case where a plurality of parts of one configuration is described separately, the same reference signs may be used, and hyphens and natural numbers may be further used.

In each embodiment of the present invention, terms such as “first”, “second”, and “third” added to each configuration are convenient labels used to distinguish each configuration, and do not have any further meaning unless otherwise described.

In the case where a sensor is arranged between a suspension and a vehicle body, a member for fixing the sensor to the suspension and the vehicle body is required. As a result, the number of parts of industrial equipment increases, and there is a possibility that the cost of manufacturing the industrial equipment increases. Further, since the sensor is fixed to the suspension or the vehicle body, the sensor is exposed to the external environment. As a result, degradation of the sensor may be accelerated. Further, in the method described in Japanese Laid-Open Patent Publication No. 2010-085215, there is a possibility that the accuracy of the detection of the vehicle height is significantly lowered in the case where the suspension or the sensor is deformed due to an unexpected external force, a flying stone, or the like.

An object of an embodiment of the present invention is to provide a displacement detection device, a displacement detection system, and industrial equipment having a lightweight and simple configuration with a small number of components and excellent long-term reliability.

In some embodiments described below, a displacement detection device, a displacement detection system, and industrial equipment having a lightweight and simple configuration with a small number of components and excellent long-term reliability are exemplified.

### 1. First Embodiment

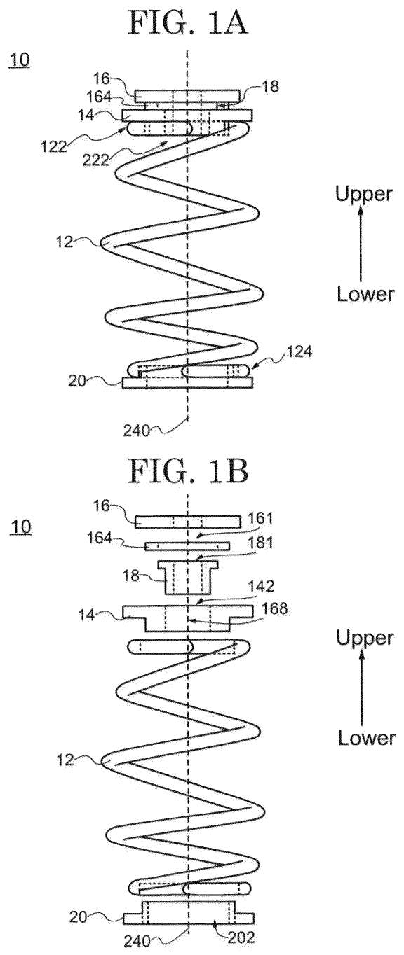

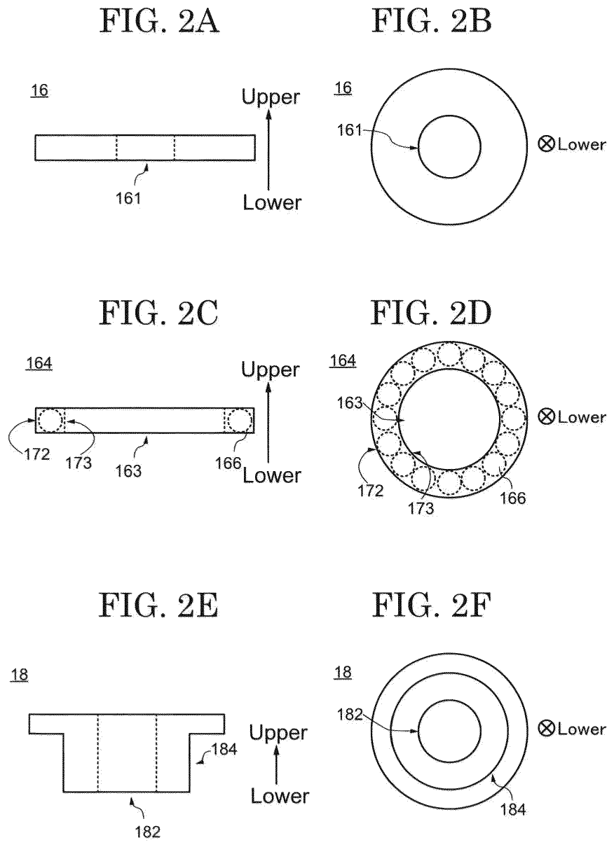

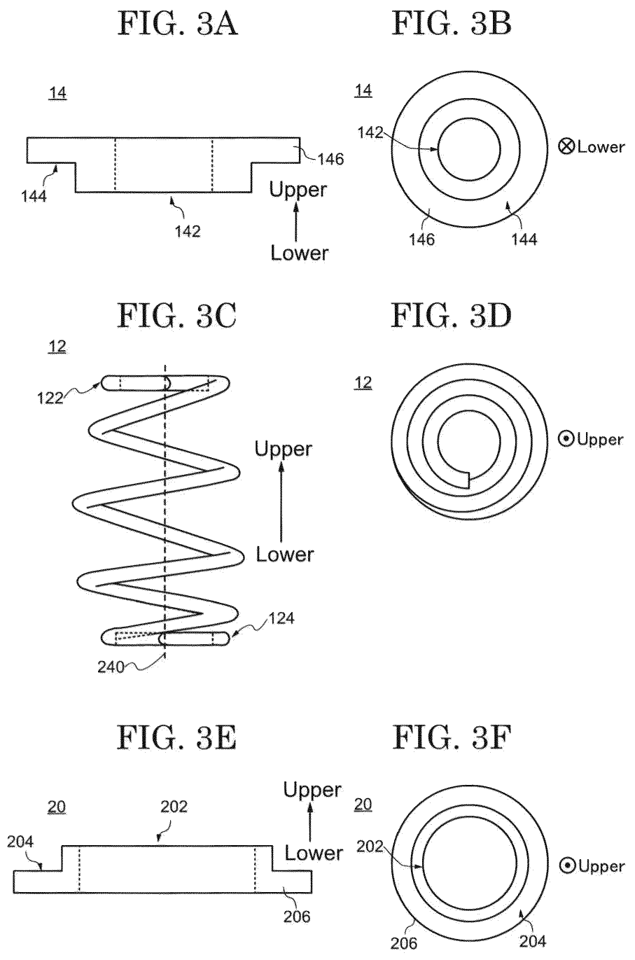

In a first embodiment, an outline of a displacement detection device 10 is shown. FIG. 1A is a schematic side view of the displacement detection device 10, and FIG. 1B is a side view of the displacement detection device 10 deployed into respective elements. FIG. 2A to FIG. 3F are enlarged views of the elements shown in the FIG. 1A and FIG. 1B. FIG. 2A and FIG. 2B are diagrams showing a first fixed member 16, FIG. 2C and FIG. 2D are diagrams showing a bearing 164, FIG. 2E and FIG. 2F are diagrams showing a detection device 18, FIG. 3A and FIG. 3B are diagrams showing a rotating member 14, FIG. 3C and FIG. 3D are diagrams showing a coil spring 12, and FIG. 3E and FIG. 3F are diagrams showing a second fixed member 20. The outline of the displacement detection device 10 will be described with reference to FIG. 1A to FIG. 3F.

### 1-1. Configuration of Displacement Detection Device 10

As shown in FIG. 1A and FIG. 1B, the displacement detection device 10 includes the first fixed member 16, the bearing 164, the detection device 18, the rotating member 14, the coil spring 12, and the second fixed member 20. In the displacement detection device 10, for convenience, a side on which the rotating member 14 is arranged with respect to the coil spring 12 is referred to as “upper”, and a side on which the second fixed member 20 is arranged is referred to as “lower”.

In the displacement detection device 10, the first fixed member 16 is fixed to a displacement detection object (not shown). The bearing 164 contacts the first fixed member 16. The detection device 18 is fixed to the first fixed member 16 and is fitted to the rotating member 14, and a convex portion 184 (see FIG. 2E) of the detection device 18 is inserted into a hollow portion 142 (see FIG. 3A) of the rotating member 14. The rotating member 14 and the second fixed member 20 are in contact with the coil spring 12.

### 1-2. Configuration of the First Fixed Member 16

The first fixed member 16 will be described with reference to FIG. 1A, FIG. 1B, FIG. 2A, or FIG. 2B. The first fixed member 16 includes a hollow portion 161. As shown in FIG. 2B, in a plan view, a shape of the first fixed member 16 and a shape of the hollow portion 161 are circular. In addition, the shape of the first fixed member 16 and the shape of the hollow portion 161 are not limited to circular shapes, and the first fixed member 16 may be any shape that can be connected to the object to be detected. For example, the shape of the first fixed member 16 may be a polygonal shape such as a quadrangle or a hexagon.

### 1-3. Configuration of the Bearing 164

The bearing 164 will be described with reference to FIG. 1A, FIG. 1B, FIG. 2C or FIG. 2D. The bearing 164 includes a hollow portion 163, an outer wall 172, an inner wall 173, and a plurality of balls 166. As the bearing 164, for example, a thrust bearing, a radial bearing, a combined bearing of radial and thrust, or the like is used. As an example, starting friction when the detection device 18 rotates together with the rotating member 14 and the coil spring 12 is small and frictional resistance is small by using the bearing 164. Thus, the bearing 164 can smoothly rotate the detection device 18. In addition, a shape of the bearing 164 and a shape of the hollow portion 163 are circular.

### 1-4. Configuration of Detection Device 18

The detection device 18 will be described with reference to FIG. 1A, FIG. 1B, FIG. 2E or FIG. 2F. The detection device 18 is connected to the rotating member 14. In the present embodiment, the detection device 18 detects an amount of rotation when the rotating member 14 rotates in accordance with deformation of the coil spring 12. The amount of rotation is, for example, a rotation angle. The detection device 18 is, for example, a potentiometer, a rotary encoder, or the like. The detection device 18 is preferably a device capable of detecting a minute rotation angle. In the displacement detection device 10, the detection device 18 is a potentiometer.

### 1-5. Configuration of Rotating Member 14, Coil Spring 12, and Second Fixed Member 20

The rotating member 14, the coil spring 12 and the second fixed member 20 will be described with reference to FIG. 1A, FIG. 1B, FIG. 3A, FIG. 3B, FIG. 3C, FIG. 3D, FIG. 3E, or FIG. 3F.

The rotating member 14 has a first coil spring mounting portion 144 and the hollow portion 142 that passes through a first flange portion 146. As shown in FIG. 3B, in a plan view, a shape of the rotating member 14 is circular. In addition, the shape of the rotating member 14 is not limited to a circular shape, and may be any rotatable shape. For example, the shape of the rotating member 14 may be similar to the shape of the first fixed member 16.

As shown in FIG. 3C, the coil spring 12 has a first end turn portion 122 and a second end turn portion 124. The first end turn portion 122 is mounted to the first coil spring mounting portion 144. For example, the first end turn portion 122 is in contact with the first coil spring mounting portion 144, and the first end turn portion 122 is in a state in which it is difficult to move with respect to the first coil spring mounting portion 144 due to frictional force. Further, the first end turn portion 122 may be connected to the first coil spring mounting portion 144 using a connecting member, or may be fixed using a fixed member. The rotating member 14 supports an upper end of the coil spring 12. The second end turn portion 124 is mounted to a second coil spring mounting portion 204. For example, similar to the first end turn portion 122, the second end turn portion 124 is in contact with the second coil spring mounting portion 204, and the second end turn portion 124 is in a state in which it is difficult to move with respect to the second coil spring mounting portion 204 due to frictional force. Further, similar to the first end turn portion 122, the second end turn portion 124 may be connected to the second coil spring mounting portion 204 by using a connecting member, and may be fixed by using a fixed member. The second fixed member 20 supports a lower end of the coil spring 12.

The second fixed member 20 has the second coil spring mounting portion 204 and a hollow portion 202 that passes through a second flange portion 206. As shown in FIG. 3F, in a plan view, a shape of the second fixed member 20 is circular. In addition, the shape of the second fixed member 20 is not limited to a circular shape, and for example, the shape of the second fixed member 20 may be any shape that can be fixed to the object to be detected equipped with the displacement detection device 10. For example, the shape of the second fixed member 20 may be similar to the shape of the first fixed member 16.

In the present embodiment, as an example, the number of turns of the coil spring 12 is five turns. Further, a diameter of the coil spring 12 becomes longer (larger) than a diameter of the rotating member 14 as it goes from the rotating member 14 to between the rotating member 14 and the second fixed member 20 (substantially middle), and becomes shorter (smaller) than a diameter between the rotating member 14 and the second fixed member 20 (substantially middle) as it goes from between the rotating member 14 and the second fixed member 20 to the second fixed member 20. The diameter of the coil spring 12 may be any diameter that can be mounted to the first coil spring mounting portion 144 and the second coil spring mounting portion 204, and may be uniform without depending on a position of the spring.

The rotating member 14 or the second fixed member 20 is made of metal, plastic, or an elastic member. The elastic member is, for example, rubber or a member including rubber. For example, in the case where the rotating member 14 or the second fixed member 20 is configured using metal, plastic, or the like, rigidity of the rotating member 14 or the second fixed member 20 can be increased.

In the displacement detection device 10, as an example, when the coil spring 12 is deformed in the same direction as a spring axis (central axis 240) by receiving an external load, the first end turn portion 122 rotates around the spring axis. Since the first fixed member 16 is fixed and does not rotate, as the first end turn portion 122 rotates, the rotating member 14 rotates in accordance with friction between the first end turn portion 122 and the rotating member 14. That is, in the displacement detection device 10, the rotating member 14 can rotate as the coil spring 12 is deformed by using the first fixed member 16 and the rotating member 14. In addition, when the coil spring 12 is deformed in a direction different from the spring axis (central axis 240) by receiving an external load, the first end turn portion 122 may rotate around the spring axis.

In addition, the coil spring 12 may be connected to the rotating member 14 by using a connecting member or a fixed member other than friction, and the rotating member 14 may rotate as the first end turn portion 122 rotates around the spring axis.

In the displacement detection device 10, an amount of rotation associated with the rotation of the rotating member 14 can be detected using the detection device 18. Further, in the displacement detection device 10, since the rotating member 14 is rotated by a stroke of the coil spring 12, displacement of the object to be detected equipped with the displacement detection device 10 can be obtained in accordance with the detected amount of rotation. In this specification, in the case where the expression “displacement of the coil spring 12” is used, the displacement of the coil spring 12 can be referred to as the stroke of the coil spring 12.

Further, the displacement detection device 10 can store the detected displacement of the object to be detected in a storage device 34. For example, it is also possible to obtain information related to the accumulation of impacts received by the object to be detected by using the displacement detection device 10 to accumulate the detected displacement of the object to be detected and to notify a user when it is time to replace the object to be detected. In addition, it is also possible to obtain information related to the degree of deterioration of the coil spring 12, and inform the user of the time to replace the coil spring 12.

For example, in a general height sensor (displacement detection device), a sensor (detection device) is mounted to a link mechanism. When a general displacement detection device is mounted to, for example, an object to be detected, the detection device is mounted to the object to be detected via a link mechanism. On the other hand, since the displacement detection device 10 according to the first embodiment does not require a link mechanism, it can be directly mounted to the object to be detected. Therefore, the displacement detection device 10 according to the first embodiment can reduce the number of components as compared with a general displacement detection device.

### 2. Second Embodiment

In a second embodiment, an outline of a displacement detection device 10A is shown. The displacement detection device 10A mainly differs from the displacement detection device 10 in configurations of a detection device, a fixed member, a bearing, and a rotating member. Other configurations are the same as the configurations of the displacement detection device 10.

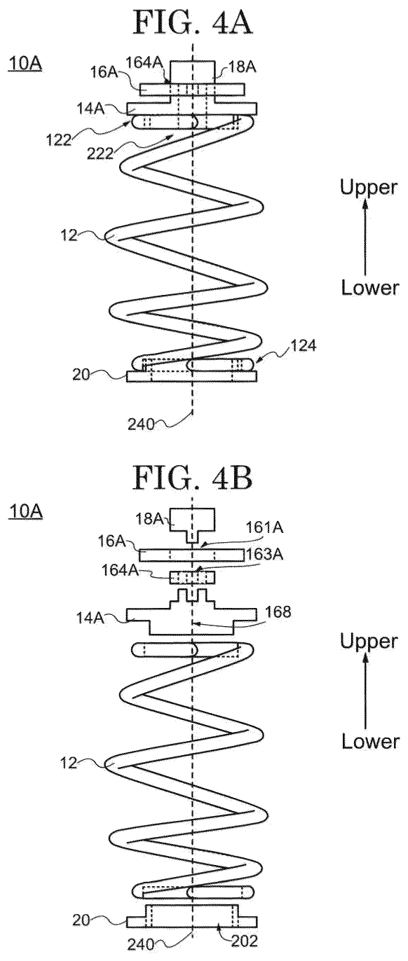

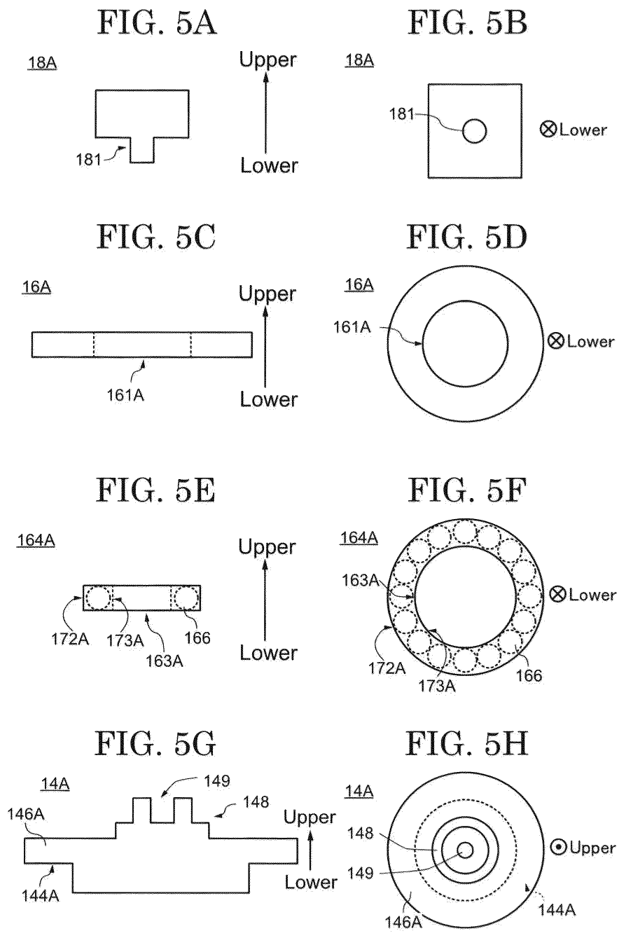

FIG. 4A is a schematic side view of the displacement detection device 10A, and FIG. 4B is a side view in which the displacement detection device 10A is deployed into respective elements. FIG. 5A to FIG. 5H are enlarged views of the elements shown in FIG. 4A and FIG. 4B. FIG. 5A and FIG. 5B are views in which a detection device 18A is shown, FIG. 5C and FIG. 5D are views in which a first fixed member 16A is shown, FIG. 5G and FIG. 5H are views in which a rotating member 14A is shown, and FIG. 5E and FIG. 5F are views in which a bearing 164A is shown. In the explanation of the displacement detection device 10A according to the second embodiment, differences from the displacement detection device 10 will mainly be explained using FIG. 4A to FIG. 5H. In the description of the second embodiment, description that is the same as or similar to the description of FIG. 1A to FIG. 3F may be omitted.

### 2-1. Configuration of Displacement Detection Device 10A

As shown in FIG. 4A and FIG. 4B, the displacement detection device 10A includes the bearing 164A, the coil spring 12, the rotating member 14A, the first fixed member 16A, the detection device 18A, and the second fixed member 20. Similar to the displacement detection device 10, in the displacement detection device 10A, for convenience, a side on which the rotating member 14A is arranged with respect to the coil spring 12 is referred to as “upper”, and a side on which the second fixed member 20 is arranged is referred to as “lower”.

In the displacement detection device 10A, the detection device 18A is fixed to the first fixed member 16A, and the first fixed member 16A is fixed to a displacement detection object (not shown). A bearing mounting portion 148 (see FIG. 5G) of the rotating member 14A is inserted into a hollow portion 163A (see FIG. 5E) of the bearing 164A, and is in rotatable contact with an inner wall 173A (see FIG. 5E) of the bearing 164A. An outer wall 172A (see FIG. 5E) of the bearing 164 is inserted so as to be in contact with a hollow portion 161A (see FIG. 5C) of the first fixed member 16A. A convex portion 181 (see FIG. 5B) of the detection device 18A is inserted into a bottomed hole 149 of the rotating member 14A and is rotatable together with the rotating member 14A. The rotating member 14A and the second fixed member 20 are in contact with the coil spring 12.

### 2-2. Configuration of Detection Device 18A

The detection device 18A will be described with reference to FIG. 4A, FIG. 4B, FIG. 5A or FIG. 5B. The detection device 18A has the same configuration and function as the configuration and function of the detection device 18. As shown in FIG. 5B, in a plan view, although a shape of the detection device 18A is a square, the shape of the detection device 18A is not limited to a square. For example, the shape of the detection device 18A may be circular similar to the detection device 18.

### 2-3. Configuration of First Fixed Member 16A and Bearing 164A

The first fixed member 16A and bearing 164A will be described with reference to FIG. 4A, FIG. 4B, FIG. 5C, FIG. 5D, FIG. 5E or FIG. 5F. The first fixed member 16A includes the hollow portion 161A. The bearing 164A includes the hollow portion 163A, the inner wall 173A, the outer wall 172A, and the ball 166. The first fixed member 16A and the bearing 164A differ in size from the first fixed member 16 and the bearing 164, but have a similar configuration and function.

### 2-4. Configuration of Rotating Member 14A, Coil Spring 12 and Second Fixed Member 20

The coil spring 12, the rotating member 14A, and the second fixed member 20 will be described with reference to FIG. 4A, FIG. 4B, FIG. 5G or FIG. 5H. The coil spring 12 and the second fixed member 20 are the same as the coil spring 12 and the second fixed member 20 in the first embodiment, and the description of the coil spring 12 and the second fixed member 20 in the second embodiment is omitted.

The rotating member 14A includes a first flange portion 146A, a first coil spring mounting portion 144A, the bearing mounting portion 148 arranged on a side opposite to the first coil spring mounting portion 144A with respect to the first flange portion 146A, and the bottomed hole 149 arranged in the bearing mounting portion 148. As shown in FIG. 5H, in a plan view, the first coil spring mounting portion 144A is disposed inside the first flange portion 146, the bearing mounting portion 148 is disposed inside the first coil spring mounting portion 144A, and the bottomed hole 149 is disposed inside the bearing mounting portion 148.

The first end turn portion 122 of the coil spring 12 is mounted to the first coil spring mounting portion 144A. The rotating member 14A supports the upper end of the coil spring 12.

The displacement detection device 10A according to the second embodiment includes the detection device 18A and does not require a link mechanism, similar to the displacement detection device 10 according to the first embodiment. Therefore, the displacement detection device 10A according to the second embodiment can achieve the same advantageous effects as the advantageous effects of the displacement detection device 10 according to the first embodiment.

### 3. Third Embodiment

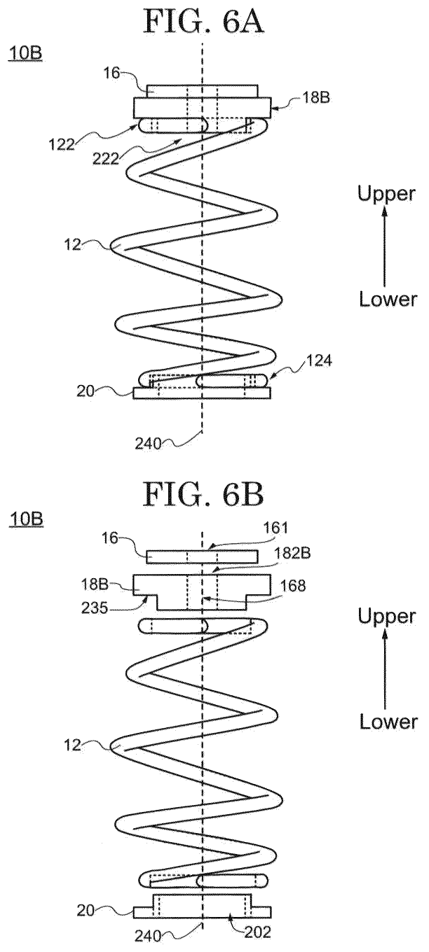

In a third embodiment, an outline of a displacement detection device 10B is shown. In the displacement detection device 10B, a detection device, a bearing, and a rotating member are integrated with the displacement detection device 10. Other configurations are the same as the configurations of the displacement detection device 10. FIG. 6A is a schematic side view of the displacement detection device 10B, and FIG. 6B is a side view in which the displacement detection device 10B is deployed into respective elements. In the explanation of the displacement detection device 10B according to the third embodiment, differences from the displacement detection device 10 will mainly be explained using FIG. 6A and FIG. 6B. In the description of the third embodiment, the description that is the same as or similar to the description of FIG. 1A to FIG. 5H may be omitted.

### 3-1. Configuration of Displacement Detection Device 10B

As shown in FIG. 6A and FIG. 6B, the displacement detection device 10B includes the first fixed member 16, a rotating member integrated detection device 18B, the coil spring 12, and the second fixed member 20. Similar to the displacement detection device 10, in the displacement detection device 10B, for convenience, a side on which the rotating member integrated detection device 18B including a rotating member is arranged with respect to the coil spring 12 is referred to as “upper”, and a side on which the second fixed member 20 is arranged is referred to as “lower”.

In the displacement detection device 10B, the first fixed member 16 is fixed to a displacement detection object (not shown). The rotating member integrated detection device 18B is in contact with the first fixed member 16. The rotating member integrated detection device 18B is mounted to the coil spring 12 using a first coil spring mounting portion 235. The coil spring 12 is disposed between the rotating member integrated detection device 18B and the second fixed member 20, and is in contact with the rotating member integrated detection device 18B and the second fixed member 20. The first fixed member 16, the coil spring 12, and the second fixed member 20 are the same as those in the first embodiment, and description of the first fixed member 16, the coil spring 12, and the second fixed member 20 in the third embodiment is omitted.

### 3-2. Construction of Rotating Member Integrated Detection Device 18B

The rotating member integrated detection device 18B includes a hollow portion 182B and the first coil spring mounting portion 235. The rotating member integrated detection device 18B has the same configuration and function as the rotating member 14, the bearing 164, and the detection device 18. The rotating member integrated detection device 18B supports the upper end of the coil spring 12.

In the displacement detection device 10B, similar to the displacement detection device 10, as an example, when the coil spring 12 is deformed in the same direction as the spring axis (central axis 240) by receiving an external load, the first end turn portion 122 rotates around the spring axis. Subsequently, since the first fixed member 16 is fixed and does not rotate, the rotating member integrated detection device 18B rotates in accordance with friction between the first end turn portion 122 and the rotating member integrated detection device 18B. That is, in the displacement detection device 10B, the rotating member integrated detection device 18B can rotate as the coil spring 12 is deformed by using the first fixed member 16 and the rotating member integrated detection device 18B. In the present embodiment, similar to the displacement detection device 10 according to the first embodiment, when the coil spring 12 is deformed in a direction different from the spring axis (central axis 240) by receiving an external load, the first end turn portion 122 may rotate around the spring axis.

In addition, the coil spring 12 may be connected to the rotating member integrated detection device 18B by using a connecting member or a fixed member other than friction, and the rotating member integrated detection device 18B may rotate as the first end turn portion 122 rotates around the spring axis.

In the displacement detection device 10B, an amount of rotation can be detected by using the rotating member integrated detection device 18B. Further, it is possible to determine displacement of the object to be detected including the displacement detection device 10B in accordance with the detected rotational speed by using the displacement detection device 10B.

The displacement detection device 10B according to the third embodiment does not require a link mechanism as in the displacement detection device 10 according to the first embodiment. Therefore, the displacement detection device 10B according to the third embodiment can achieve the same advantageous effects as the advantageous effects of the displacement detection device 10 according to the first embodiment.

### 4. Fourth Embodiment

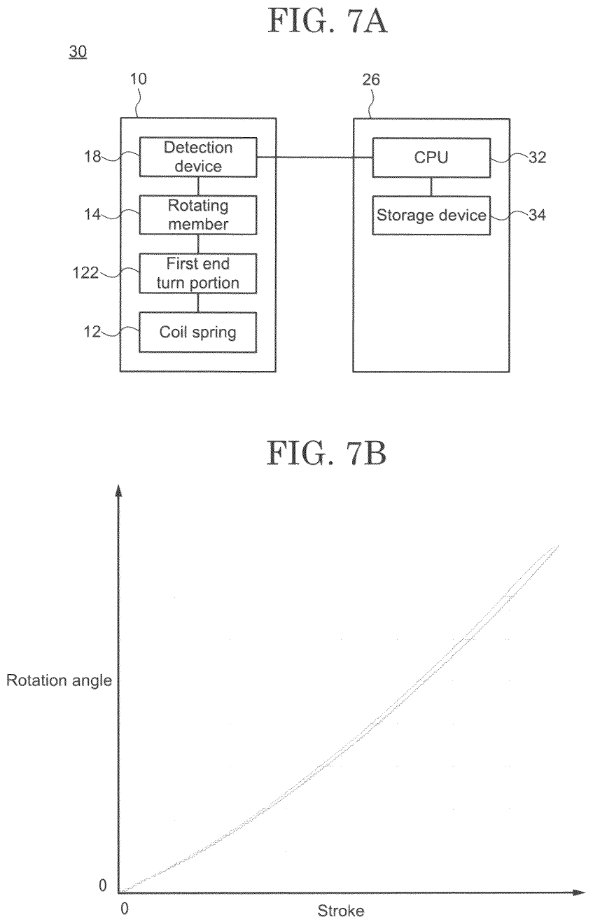

In a fourth embodiment, a displacement detection system 30 including the displacement detection device 10 will be described. FIG. 7A is a functional block diagram showing an example of the displacement detection device 30, and FIG. 7B is a graph showing a relationship between a rotation angle of the rotating member 14 and a stroke of the coil spring 12.

As shown in FIG. 7A, the displacement detection device 30 includes the displacement detection device 10 and an electronic control unit 26 (Electronic Control Unit (ECU) 26) electrically connected to the displacement detection device 10. Since the displacement detection device 10 is described with reference to FIG. 1A to FIG. 2F, detailed description thereof will be omitted.

The electronic control unit 26 includes, for example, a CPU 32 and the storage device 34 electrically connected to the CPU 32. The electronic control unit 26 may be referred to as an arithmetic circuit, for example. The storage device 34 includes, for example, a memory device such as a non-volatile memory. The electronic control unit 26 transmits and receives signals to and from the displacement detection device 10 or industrial equipment including the displacement detection device 10.

In a graph shown in FIG. 7B, a vertical axis is the rotational angle and a horizontal axis is the stroke of the helical spring 12. That is, as the stroke of the coil spring 12 increases, the rotation angle of the rotating member 14 increases.

The storage device 34 includes a formula in which the rotational angle of the rotating member 14 is determined with respect to the stroke of the coil spring 12 as shown in the graph of FIG. 7B. Further, a table may be provided in which the rotational angle of the rotating member 14 and the stroke of the coil spring 12 are associated with each other as shown in the graph of FIG. 7B.

Here, an operation method of the displacement detection device 30 will be briefly described with reference to FIG. 7A. First, when the coil spring 12 is deformed in the same direction as the spring axis (central axis 240) by receiving an external load, the first end turn portion 122 rotates around the spring axis. The detection device 18 detects a rotation angle associated with the rotation. Subsequently, the detection device 18 transmits a signal (first signal) indicating that the rotation angle has been detected to the electronic control unit 26. The signal indicating that the rotation angle has been detected includes a rotation angle (also referred to as rotation angle data). The CPU 32 in the electronic control unit 26 receives the signal and processes the signal. The CPU 32 reads the stroke of the coil spring 12 and the displacement of the object to be detected according to the rotational angle included in the signal from the storage device 34, based on results of the processing of the signal. That is, the displacement detection system 30 can calculate the stroke of the coil spring 12 in accordance with the rotation angle, and detect an absolute value of a dimension of the object to be detected by using the stroke of the coil spring 12 and a length of the spring given in advance.

### 5. Fifth Embodiment

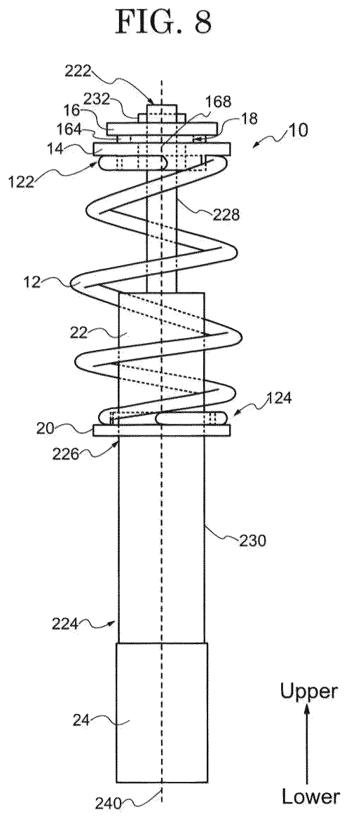

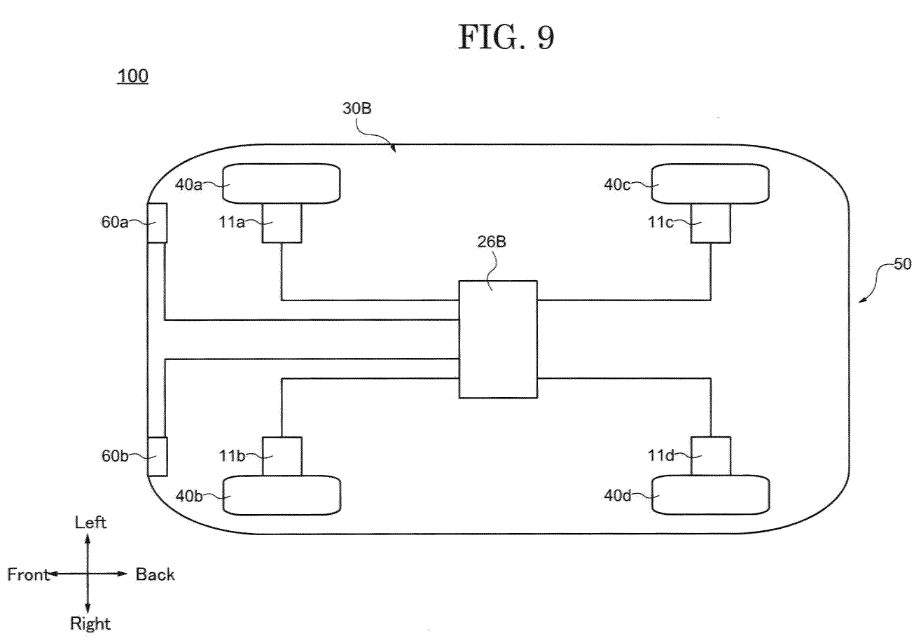

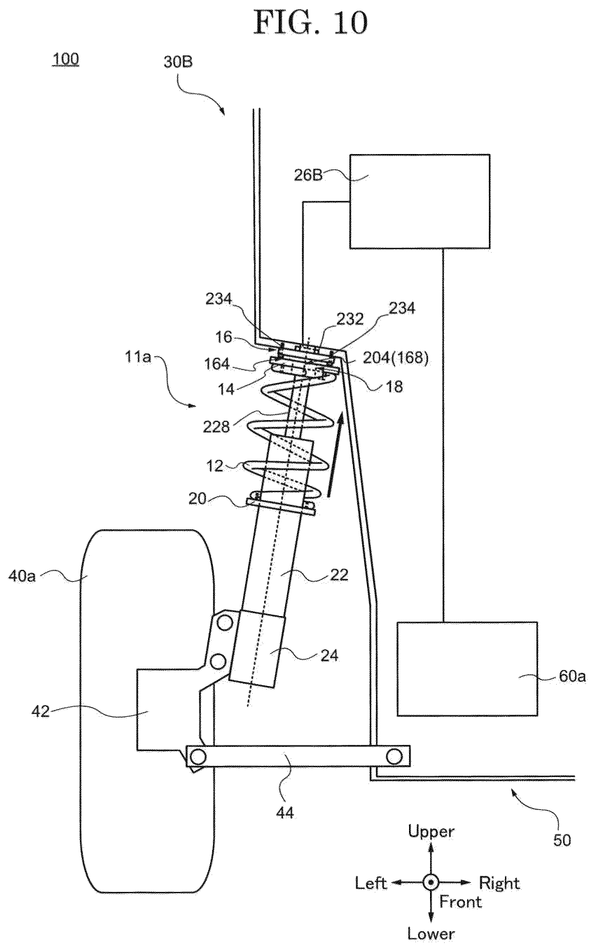

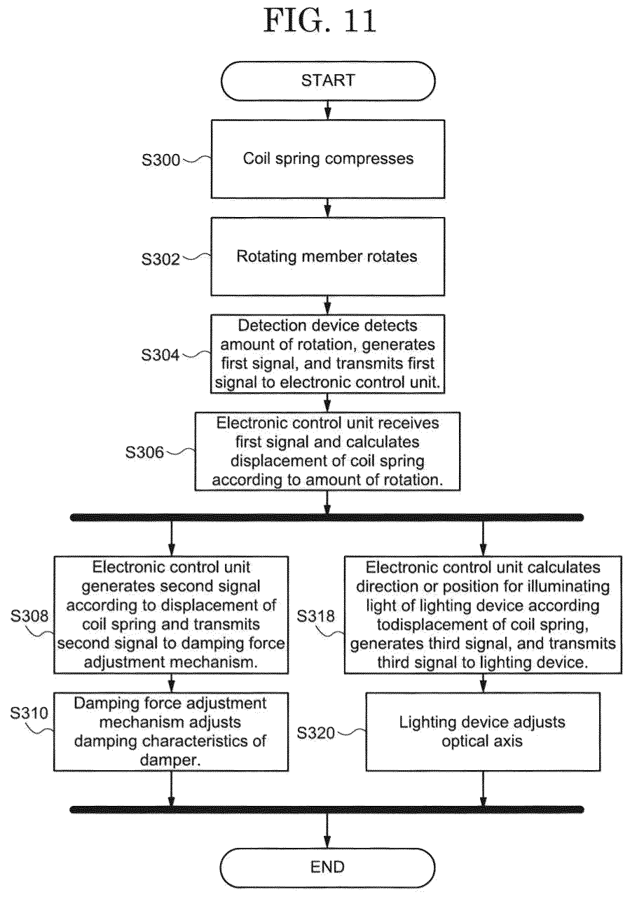

In a fifth embodiment, an example in which the displacement detection system 30 is applied to an industrial device (a displacement detection system 30B) will be described. Specifically, the displacement detection system 30 is used for displacement detection of a vehicle. The displacement detection system 30B is used to detect a height of a vehicle body 50 of a vehicle 100 from the ground, and to control lighting devices 60a and 60b. FIG. 8 is a side view showing the displacement detection device 10 to which a damper 22 is mounted, FIG. 9 is a schematic view showing an example in which the displacement detection system 30B is mounted on the vehicle 100, FIG. 10 is a front view of a part of the application shown in FIG. 9, and FIG. 11 is a flow chart showing an example of an operation method of the displacement detection system 30B.

### 5-1. Configuration of Damper 22

The damper 22 will be described with reference to FIG. 8. The damper 22 includes a rod portion 228 including a third end portion 222 and a cylinder 230 having a fourth end portion 224. The damper 22 is inserted into the hollow portion 202 of the second fixed member 20, an inside of a spiral of the coil spring 12, and the hollow portion 142 of the rotating member 14. The rod portion 228 is fixed to the first fixed member 16 using a nut 232. Further, the cylinder 230 is connected to and fixed to a part of the periphery 226 of the second fixed member 20. As a result, the damper 22 is connected to and fixed to the first fixed member 16 and the second fixed member 20. The fourth end portion 224 is connected to and fixed to a mounting portion 24. In addition, the damper 22 may include a mechanism that adjusts the damping characteristics of the damper 22 (a damping force adjustment mechanism, not shown).

### 5-2. Configuration of Displacement Detection Device 30B

As shown in FIG. 9, the vehicle 100 includes at least the vehicle body 50, the displacement detection system 30B, wheels 40a to 40d, and the lighting devices 60a and 60b. The wheel 40a and the wheel 40b are front wheels arranged in the front of the vehicle 100, and the wheel 40c and the wheel 40d are rear wheels arranged in the rear of the vehicle 100.

The displacement detection system 30B comprises four displacement detection devices 11a to 11d and an electronic control unit 26B electrically connected to the displacement detection devices 11a to 11d. The displacement detection device 11a is connected between the wheel 40a and the vehicle body 50. Similar to the displacement detection device 11a, the displacement detection devices 11b to 11d are connected between the wheels 40b to 40d and the vehicle body 50. The lighting devices 60a and 60b are electrically connected to the electronic control unit 26B, and optical axes of the lighting device 60a and the lighting device 60b are controlled according to strokes of the displacement detection devices 11a to 11d.

Each of the displacement detection devices 11a to 11d have the same configurations and functions as the configuration and function of the displacement detection device 10. The electronic control unit 26B has the same configuration and function as the electronic control unit 26. Therefore, the description of the displacement detection devices 11a to 11d and the electronic control unit 26B is omitted here, and will be described only when required. In addition, the lighting devices 60a and 60b have similar functions and configurations. Further, for example, the electronic control unit 26B may include the electronic control unit 26 capable of independently controlling each of the four displacement detection devices 11a to 11d, and may be configured to be independently controllable using a switch that allows for connecting to each of the four displacement detection devices 11a to 11d. The electronic control unit 26B can detect displacement of the wheels 40a to 40d from the ground and calculate a posture of the vehicle 100.

Here, the electronic control unit 26B includes the electronic control unit 26 capable of independently controlling each of the four displacement detection devices 11a to 11d, and the displacement detection device 11a, the wheel 40a, the electronic control unit 26B, and the lighting device 60a will be described, and the description of the displacement detection devices 11b to 11d, the wheels 40b to 40d, and the lighting device 60b is omitted.

With reference to FIG. 10, the vehicle 100 equipped with the displacement detection system 30B will be described. For example, the first fixed member 16 of the displacement detection device 11a is connected to the vehicle body 50 by using a mounting member such as a bolt 234. The attachment member may be configured using a metal, plastic, or elastic member, similar to the rotating member 14 and the second fixed member 20.

The mounting portion 24 of the displacement detection device 11a is connected to a knuckle 42. The knuckle 42 functions as a bearing of the wheel 40a and a connecting portion with the vehicle body 50. A connecting member 44 has a function of connecting one end to the knuckle 42, the other end to the vehicle body 50, and connecting the wheel 40a to the vehicle body 50.

The displacement detection device 11a according to the fifth embodiment is a device functioning as a so-called suspension. Since the displacement detection device 11a includes the detection device 18 and is connected to the vehicle body 50 and the knuckle 42, there is no need to individually fix the detection device 18 to the suspension and the vehicle body 50. As a consequence, since a member for fixing the detection device 18 to the suspension and the vehicle body 50 is not required, the number of components is small in the vehicle 100 including the displacement detection system 30B, and the manufacturing cost can be suppressed.

For example, in the vehicle 100 including the displacement detecting system 30B, position information of the vehicle 100 and displacement from the ground can be associated with each other using a GPS or the like after the displacement of the vehicle body 50 from the ground is detected. In the case of passing through the past road again, a state of the road can be grasped in advance by using information in which position information of the vehicle 100 and displacement from the ground are linked.

Further, in the vehicle 100 equipped with the displacement detection system 30B, the detected information and air pressure of a tire can be associated with each other after the displacement of the vehicle body 50 from the ground is detected. For example, it is possible to determine whether or not the air pressure of the tire is lowered and to grasp deterioration of the tire by using data in which the detected information is associated with the air pressure of the tire.

Further, in the vehicle 100 including the displacement detecting system 30B, for example, a formula in which the displacement of the vehicle body 50 from the ground and a loading amount are associated with each other can be stored in advance in the storage device 34. In this way, in the vehicle 100 equipped with the displacement detection system 30B, a loading amount can be calculated by using the displacement of the vehicle body 50 from the ground, and in the case where the loading amount is large, braking force of the rear wheel can be weakened to suppress brake lock.

### 3-3. Operation Method of Displacement Detection System 30B

An operation method of the displacement detection system 30B will be described with reference to FIG. 7, FIG. 10 or FIG. 11. First, a step 300 (S300) will be described. The displacement detection system 30B starts to operate, for example, the vehicles 100 move on a convex ground (road surface). In the step 300 (S300), the coil spring 12 contracts, as indicated by a solid arrow in FIG. 10.

In the following step 302 (S302), the rotating member 14 rotates. Further, in step 304 (S304), the detection device 18 detects a rotation angle associated with rotation. In addition, the detection device 18 generates a first signal indicating that the rotational angle has been detected, and transmits the first signal to the electronic control unit 26B. Here, the first signal includes the rotation angle (rotation angle data).

In a following step 306 (S306), the CPU 32 (see FIG. 7A) included in the electronic control unit 26B receives the first signal and processes the first signal. In addition, the CPU 32 reads out the stroke of the coil spring 12 and the displacement of the object to be detected according to the rotational angle from the storage device 34 in accordance with the first signal. That is, the CPU 32 calculates a length of the coil spring 12 using the first signal detected in accordance with the rotational angle.

In a following step 308 (S308), the electronic control unit 26B generates a second signal and transmits the second signal to the damper 22 including the damping force adjustment mechanism. Here, the second signal includes the displacement of the object to be detected (displacement data of the object to be detected).

In addition, the displacement detection system 30B also performs a step 318 (S318) in parallel with the step 308. In the step 318, the electronic control unit 26B calculates the posture of the vehicle 100 according to the stroke of the coil spring 12. In addition, the electronic control unit 26B calculates directions or positions in which the lighting devices 60a and 60b will illuminate the light according to the posture of the vehicle 100. Further, the electronic control unit 26B generates a third signal and transmits the third signal to the lighting devices 60a and 60b. Here, the third signal includes, for example, the direction or the position of the illumination according to the posture of the vehicle 100 based on the displacement of the object to be detected.

In a following step 310 (S310), the damper 22 including the damping force adjustment mechanism receives the second signal, and calculates speed data obtained by differentiating the displacement data based on the displacement data of the object to be detected included in the second signal. The damper 22 including the damping force adjustment mechanism adjusts the damping characteristics of the damper 22 based on the speed data. As a result, ride comfort of the vehicle 100 is improved by using the displacement detection system 30.

The displacement detection system 30B also performs a step 320 (S320) in parallel with the step 310. In the step 320, the lighting device 60a receives the third signal. The optical axis of the lighting device 60a can be adjusted based on the direction or the position of the illumination according to the posture of the vehicle 100 included in the third signal.

### 6. Sixth Embodiment

In a sixth embodiment, an example of arrangements of a detection device in a displacement detection device will be described. A displacement detection device 10C according to the sixth embodiment mainly differs from the displacement detection device 10 in an arrangement of a detection device, a fixed member, a bearing, and a rotating member. Other configurations are the same as the configurations of the displacement detection device 10.

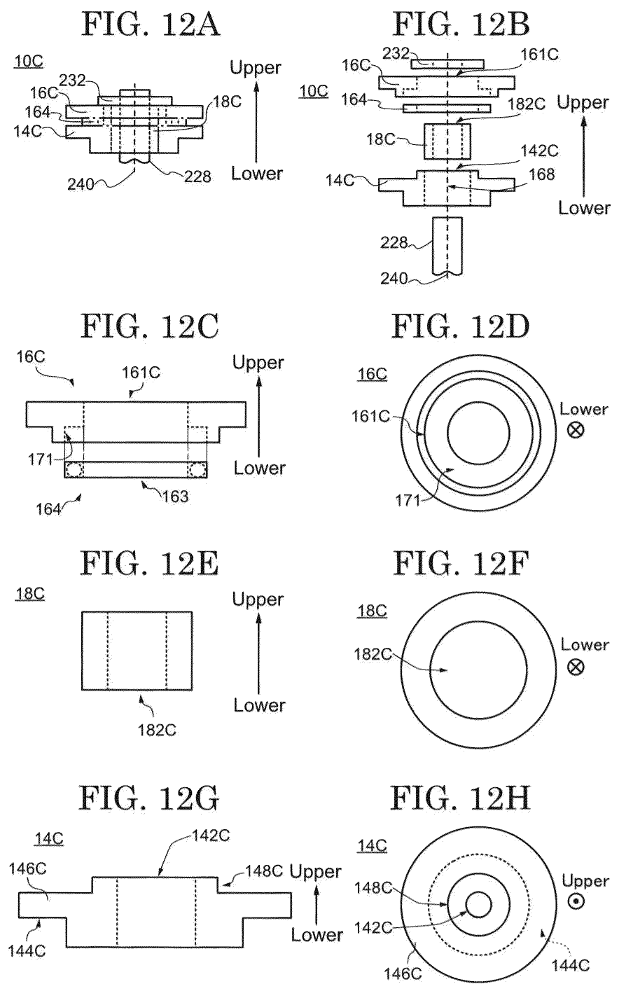

FIG. 12A is a schematic side view of the displacement detection device 10C, and FIG. 12B is a side view in which the displacement detection device 10C is deployed into respective elements. FIG. 12C to FIG. 12H are enlarged views of the elements shown in the FIG. 12A and FIG. 12B. FIG. 12C and FIG. 12D are diagrams showing a first fixed member 16C and the bearing 164, FIG. 12E and FIG. 12F are diagrams showing a detection device 18C, and FIG. 12G and FIG. 12H are diagrams showing a rotating member 14C. In the explanation of the displacement detection device 10C according to the sixth embodiment, differences from the displacement detection device 10 will mainly be explained using FIG. 12A to FIG. 12H. In the description of the sixth embodiment, the description that is the same as or similar to the description of FIG. 1A to FIG. 11 may be omitted.

### 6-1. Configuration of Displacement Detection Device 10C

As shown in FIG. 12A and FIG. 12B, the displacement detection device 10C includes the first fixed member 16C, the bearing 164, the detection device 18C, and the rotating member 14C. In the displacement detection device 10C shown in FIG. 12A and FIG. 12B, part of the coil spring 12, the second fixed member 20, and the damper 22 are omitted. The bearing 164, the coil spring 12, and the second fixed member 20 are the same as those in the first embodiment, and the description of the bearing 164, the coil spring 12, and the second fixed member 20 in the sixth embodiment will be omitted. Similar to the displacement detection device 10, in the displacement detection device 10C, for convenience, a side on which the rotating member 14C is arranged with respect to the coil spring 12 is referred to as “upper”, and a side on which the second fixed member 20 is arranged is referred to as “lower”.

In the displacement detection device 10C, the bearing 164 is mounted so as to be in contact with an inner wall 171 of the first fixed member 16C. The detection device 18C is inserted into a hollow portion 142C of the rotating member 14C. A bearing mounting portion 148C of the rotating member 14C is rotatably inserted into the hollow portion 163 of the bearing 164 and a stepped hollow portion 161C of the first fixed member 16C. The rotating member 14C and the second fixed member 20 are in contact with the coil spring 12. Further, the rod portion 228 of the damper 22 is inserted into a hollow portion 182C, and is fixed to the first fixed member 16C by using the nut 232.

### 6-2. Configuration of First Fixed Member 16C

The first fixed member 16C and the bearing 164 will be described with reference to FIG. 12A, FIG. 12B, FIG. 12C or FIG. 12D. The first fixed member 16C includes the interior wall 171 and the stepped hollow portion 161C. As shown in FIG. 12D, in a plan view, the bearing 164 is mounted so as to be in contact with the inner wall 171. The inner wall 171 is disposed inside an outer diameter of the first fixed member 16C, and the stepped hollow portion 161C is arranged inside the inner wall 171. A shape of the first fixed member 16C, a shape of the inner wall 171, and a shape of the stepped hollow portion 161C are circular. The first fixed member 16C may have a shape connectable to the object to be detected, and may have a shape similar to the shape of the first fixed member 16.

### 6-3. Configuration of Detection Device 18C

The detection device 18C will be described with reference to FIG. 12A, FIG. 12B, FIG. 12E or FIG. 12F. The detection device 18C does not include the convex portion 184 and a hollow portion 182 and includes the hollow portion 182C with respect to the detection device 18. Since other configurations and functions are the same as the configurations and functions of the detection device 18, detailed description thereof will be omitted.

### 6-4. Configuration of Rotating Member 14C

The rotating member 14C will be described with reference to FIG. 12A, FIG. 12B, FIG. 12G or FIG. 12H. The rotating member 14C includes a first flange portion 146C, a first coil spring mounting portion 144C connected to the first flange portion 146C, the bearing mounting portion 148C arranged on the first flange portion 146C and opposed to the first coil spring mounting portion 144C, and the hollow portion 142C. As shown in FIG. 12H, in a plan view, the first coil spring mounting portion 144C is disposed inside the first flange portion 146C, the bearing mounting portion 148C is disposed inside the first coil spring mounting portion 144C, and the hollow portion 142C is disposed inside the bearing mounting portion 148C.

The first end turn portion 122 of the coil spring 12 is mounted to the first coil spring mounting portion 144C. The rotating member 14C supports the upper end of the coil spring 12.

In the displacement detection device 10C according to the sixth embodiment, the detection device 18C is disposed between the rod portion 228 and the rotating member 14C and is protected from the outside. That is, the detection device 18C is not exposed from the displacement detection device 10C, and it is difficult to visually recognize from the outside. Therefore, the detection device 18C is not damaged by flying stones or unexpected external loads.

### 7. Seventh Embodiment

In a seventh embodiment, an example of an arrangement of a detection device in a displacement detection device will be described. A displacement detection device 10D according to the seventh embodiment mainly differs from the displacement detection device 10 in an arrangement of a detection device, a fixed member, a bearing, and a rotating member. Other configurations are the same as the configurations of the displacement detection device 10.

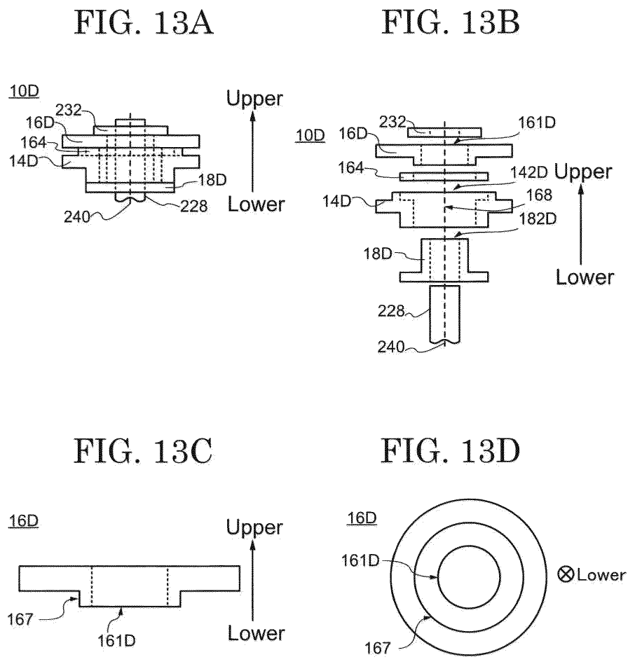

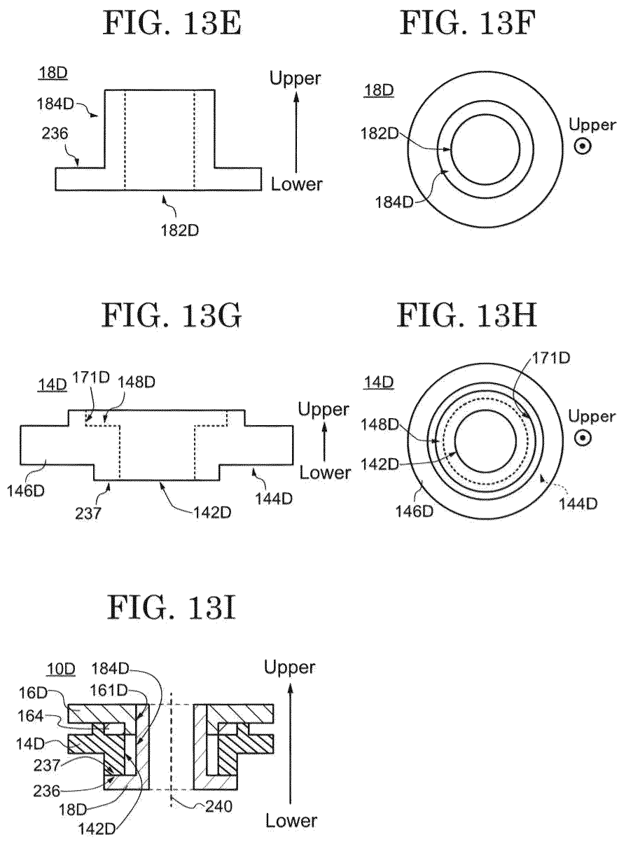

FIG. 13A is a schematic side view of the displacement detection device 10D, and FIG. 13B is a side view in which the displacement detection device 10D is deployed into respective elements. FIG. 13C to FIG. 13H are enlarged views of the elements shown in FIG. 13A and FIG. 13B. FIG. 13C and FIG. 13D are diagrams showing a first fixed member 16D, FIG. 13E and FIG. 13F are diagrams showing a detection device 18D, FIG. 13G and FIG. 13H are diagrams showing a rotating member 14D, FIG. 13I is a diagram showing a cross section of the first fixed member 16D, the rotating member 14D, the bearing 164, and the detection device 18D of the displacement detection device 10D according to the seventh embodiment. In the explanation of the displacement detection device 10D according to the seventh embodiment, differences from the displacement detection device 10 will mainly be explained using FIG. 13A to FIG. 13I. In the description of the seventh embodiment, the description that is the same as or similar to the description of FIG. 1A to FIG. 12H may be omitted.

### 7-1. Configuration of Displacement Detection Device 10D

As shown in FIG. 13A, FIG. 13B or FIG. 13I, the displacement detection device 10D includes the first fixed member 16D, the bearing 164, the rotating member 14D, and the detection device 18D. In the displacement detection device 10D shown in FIG. 13A and FIG. 13B, part of the coil spring 12, the second fixed member 20, and the damper 22 are omitted. Further, the bearing 164, the coil spring 12, and the second fixed member 20 are the same as those in the first embodiment, and the description of the bearing 164, the coil spring 12, and the second fixed member 20 in the seventh embodiment is omitted. Similar to the displacement detection device 10, in the displacement detection device 10D, for convenience, a side on which the rotating member 14D is arranged with respect to the coil spring 12 is referred to as “upper”, and a side on which the second fixed member 20 is arranged is referred to as “lower”.

In the displacement detection device 10D, the bearing 164 is disposed so as to be in contact with a bearing mounting portion 167 of the first fixed member 16D. In addition, the first fixed member 16D to which the bearing 164 is mounted is mounted such that the bearing 164 is in contact with an inner wall 171D of the rotating member 14D and a bearing mounting portion 148D. Here, the bearing 164 is sandwiched between the bearing mounting portion 167 and the inner wall 171D. A convex portion 184D of the detection device 18D is inserted into a stepped hollow portion 142D of the rotating member 14D and a hollow portion 161D of the first fixed member 16D. The convex portion 184D of the detection device 18D is connected to and fixed to a part of the hollow portion 161D of the first fixed member 16D, and a rotating member mounting portion 236 of the detection device 18D is connected to and fixed to a detection device mounting portion 237 of the rotating member 14D. A portion fixed to the first fixed member 16D and a portion fixed to the rotating member 14D are configured to be relatively rotatable, and a rotational angle can be acquired by using the detection device 18D. The first end turn portion 122 of the coil spring 12 is mounted to a first coil spring mounting portion 144D of the rotating member 14D. The rotating member 14D and the second fixed member 20 are in contact with the coil spring 12. Further, the rod portion 228 of the damper 22 is inserted into a hollow portion 182D, and is fixed to the first fixed member 16D by using the nut 232.

### 7-2. Configuration of First Fixed Member 16D

The first fixed member 16D will be described with reference to FIG. 13A, FIG. 13B, FIG. 13C or FIG. 13D. The first fixed member 16D includes the bearing mount 167 and the hollow portion 161D. As shown in FIG. 13D, in a plan view, the bearing mounting portion 167 is disposed inside an outer diameter of the first fixed member 16D, and the hollow portion 161D is arranged inside the bearing mounting portion 167. A shape of the first fixed member 16D, a shape of the bearing mounting portion 167, and a shape of the hollow portion 161D are circular. The first fixed member 16D may have a shape connectable to the object to be detected, and may have a shape similar to the shape of the first fixed member 16.

### 7-3. Configuration of Detection Device 18D

The detection device 18D will be described with reference to FIG. 13A, FIG. 13B, FIG. 13E or FIG. 13F. The detection device 18D does not include the convex portion 184 and the hollow portion 182, but includes the rotating member mounting portion 236, the convex portion 184D, and the hollow portion 182D with respect to the detection device 18. The convex portion 184D is disposed inside an outer diameter of the detection device 18D, and the hollow portion 182D is disposed inside the convex portion 184D. Since other configurations and functions are the same as the configurations and functions of the detection device 18, detailed description thereof will be omitted.

### 7-4. Configuration of Rotating Member 14D

FIG. 13A, FIG. 13B, FIG. 13G or FIG. 13H will be used to explain the rotating member 14D. The rotating member 14D includes a first flange portion 146D, the first coil spring mounting portion 144D connected to the first flange portion 146D, the bearing mounting portion 148D arranged to the first flange portion 146D and opposed to the first coil spring mounting portion 144D, an inner wall 171D, the detection device mounting portion 237, and the stepped hollow portion 142D. As shown in FIG. 13H, in a plan view, the bearing mounting portion 148D is disposed inside the first flange portion 146D, the first coil spring mounting portion 144D is disposed inside the bearing mounting portion 148D, and the stepped hollow portion 142D is disposed inside the bearing mounting portion 148D.

The first end turn portion 122 of the coil spring 12 is mounted to the first coil spring mounting portion 144D. The rotating member 14D supports the upper end of the coil spring 12.

Similar to the displacement detection device 10C according to the sixth embodiment, in the displacement detection device 10D according to the seventh embodiment, the detection device 18D is disposed between the rod portion 228 and the rotating member 14D and is protected from the outside. That is, the detection device 18D is not exposed from the displacement detection device 10D, and it is difficult to visually recognize from the outside. Therefore, the detection device 18D is not damaged by flying stones or unexpected external loads.

### 8. Eighth Embodiment

In an eighth embodiment, an example of an arrangement of a detection device in a displacement detection device will be described. A displacement detection device 10E according to the eighth embodiment mainly differs from the displacement detection device 10 in an arrangement of a detection device, a fixed member, a bearing, and a rotating member. Other configurations are the same as the configurations of the displacement detection device 10.

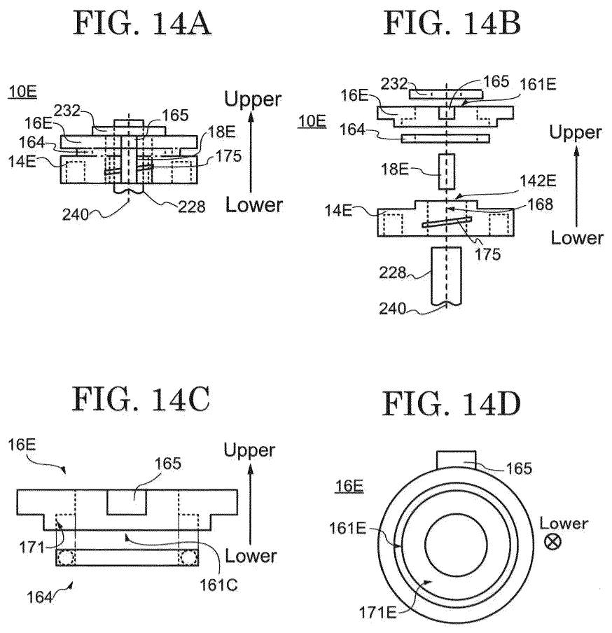

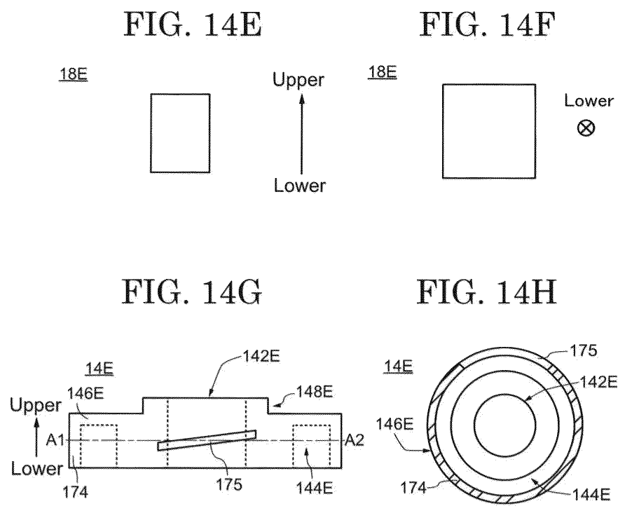

FIG. 14A is a schematic side view of the displacement detection device 10E, and FIG. 14B is a side view in which the displacement detection device 10E is deployed into respective elements. FIG. 14C to FIG. 14H are enlarged views of the elements shown in the FIG. 14A and FIG. 14B. FIG. 14C and FIG. 14D are diagrams showing a first fixed member 16E, FIG. 14E and FIG. 14F are diagrams showing a detection device 18E, and FIG. 14G and FIG. 14H are diagrams showing a rotating member 14E. In the description of the displacement detection device 10E according to the eighth embodiment, differences from the displacement detection device 10 will mainly be described using FIG. 14A to FIG. 14H. In the description of the eighth embodiment, the description that is the same as or similar to the description of FIG. 1A to FIG. 13I may be omitted.

### 8-1. Configuration of Displacement Detection Device 10E

As shown in FIG. 14A and FIG. 14B, the displacement detection device 10E includes the first fixed member 16E, the bearing 164, the rotating member 14E, and the detection device 18E. In the displacement detection device 10E shown in FIG. 14A and FIG. 14B, part of the coil spring 12, the second fixed member 20, and the damper 22 are omitted. In addition, the bearing 164, the coil spring 12, and the second fixed member 20 are the same as the bearing 164, the coil spring 12, and the second fixed member 20 in the first embodiment, and the description of the bearing 164, the coil spring 12, and the second fixed member 20 in the eighth embodiment is omitted. Similar to the displacement detection device 10, in the displacement detection device 10E, for convenience, a side on which the rotating member 14E is arranged with respect to the coil spring 12 is referred to as “upper”, and a side on which the second fixed member 20 is arranged is referred to as “lower”.

In the displacement detection device 10E, the bearing 164 is arranged so as to be in contact with the inner wall 171 of the first fixed member 16E. In addition, the first fixed member 16E to which the bearing 164 is mounted is mounted such that the bearing 164 is in contact with the bearing mounting portion 148E of the rotating member 14E. In this case, the rotating member 14E is rotatably disposed with respect to the bearing 164. In addition, the bearing 164 is sandwiched between the inner wall 171 and the bearing mounting portion 148E. The detection device 18E is mounted to a detection device mounting portion 165 mounted to the first fixed member 16E. The first end turn portion 122 of the coil spring 12 is mounted so as to be in contact with the first coil spring mounting portion 144E of the rotating member 14E. The rotating member 14E and the second fixed member 20 are in contact with the coil spring 12. Further, the rod portion 228 of the damper 22 is inserted into a hollow portion 142E, and is fixed to the first fixed member 16E by using the nut 232.

### 8-2. Configuration of First Fixed Member 16E

The first fixed member 16E will be described with reference to FIG. 14A, FIG. 14B, FIG. 14C or FIG. 14D. The first fixed member 16E differs from the first fixed member 16C in that it includes the detection device mounting portion 165. In the first fixed member 16E, other configurations and functions are the same as the configurations and functions of the first fixed member 16C, and therefore, explanation thereof will be omitted. As shown in FIG. 14D, in a plan view, the detection device mounting portion 165 is mounted so as to protrude from an outer periphery of the first fixed member 16E.

### 8-3. Configuration of Detection Device 18E

The detection device 18E will be described using FIG. 14A, FIG. 14B, FIG. 14E or FIG. 14F. The detection device 18E differs from the detection device 18 in that the detection device 18E does not include the convex portion 184 and the hollow portion 182. In addition, the detection device 18E also includes a laser oscillator (not shown). For example, the detection device 18E can compare a position at which a laser beam is emitted with a position at which the emitted laser beam is returned, and convert an amount of rotation associated with the rotation of the rotating member 14E into a linear displacement. In the displacement detection device 10E, although a shape of the detection device 18E is a quadrangle, the shape of the detection device 18E is not limited to a quadrangle.

### 8-4. Configuration of Rotating Member 14E

The rotating member 14E will be described with reference to FIG. 14A, FIG. 14B, FIG. 14G or FIG. 14H. FIG. 14G is a cross-sectional view of the rotating member 14E taken along a line A1-A2 shown in FIG. 14H. The rotating member 14E includes a first flange portion 146E, the bearing mounting portion 148E connected to the first flange portion 146E, and the hollow portion 142E. The first flange portion 146E includes the first coil spring mount 144E. Further, the first flange portion 146E includes a cylindrical portion 174 including a long groove 175. The long groove 175 is provided obliquely from an upper side to a lower side. As shown in FIG. 14G, in the side view, the first coil spring mounting portion 144E is disposed inside an outer periphery of the rotating member 14E, the bearing mounting portion 148E is disposed inside the first coil spring mounting portion 144E, and the hollow portion 142E is disposed inside the bearing mounting portion 148E.

The first end turn portion 122 of the coil spring 12 is mounted to the first coil spring mounting portion 144E. The rotating member 14E supports the upper end of the coil spring 12.

In the displacement detection device 10E, a laser beam is emitted around the long groove 175 using the laser oscillator included in the detection device 18E. As the coil spring 12 deforms, the rotating member 14E rotates, and a position of the long groove 175 irradiated with the laser beam changes downward from a position irradiated with the laser beam first. The amount of rotation of the rotating member 14 can be converted into a linear displacement in the vertical direction by detecting the reflection of the laser light at this time.

### 9. Ninth Embodiment

In a ninth embodiment, an example of an arrangement of a detection device in a displacement detection device will be described. A displacement detection device 10F according to the ninth embodiment mainly differs from the displacement detection device 10 in an arrangement of a detection device, a fixed member, a bearing, and a rotating member. Other configurations are the same as the configurations of the displacement detection device 10.

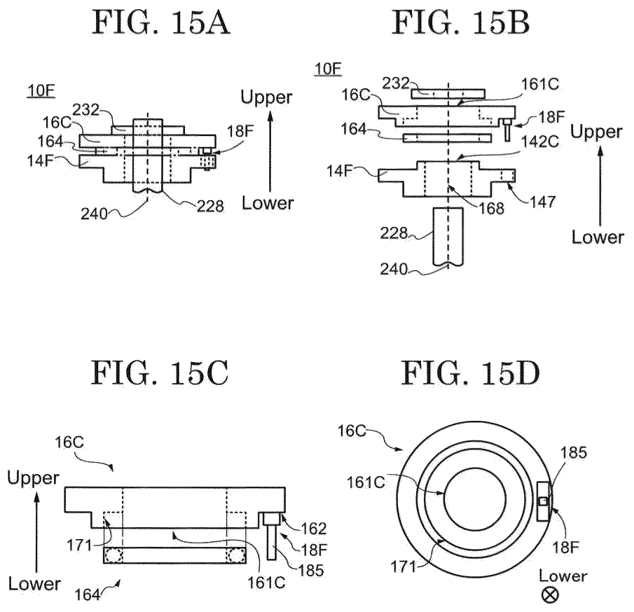

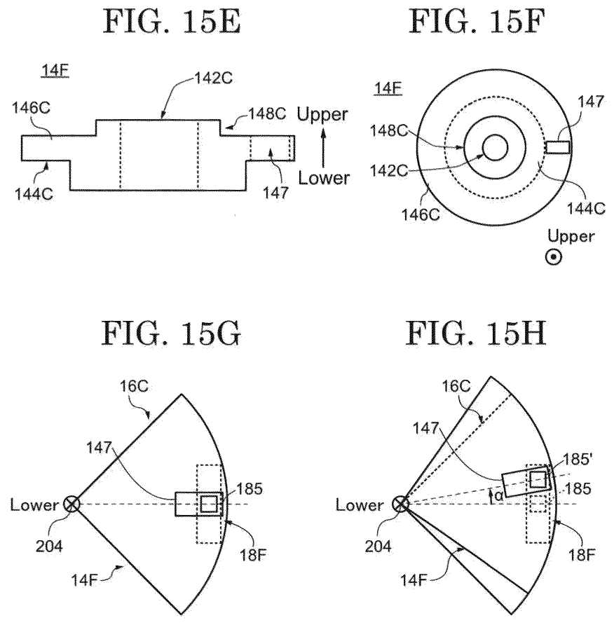

FIG. 15A is a schematic side view of the displacement detection device 10F, and FIG. 15B is a side view in which the displacement detection device 10F is deployed into respective elements. FIG. 15C to FIG. 15H are enlarged views of the elements shown in the FIG. 15A and FIG. 15B. FIG. 15C and FIG. 15D are views showing the first fixed member 16C, the bearing 164, and the detection device 18F, FIG. 15E and FIG. 15F are views showing a rotating member 14F, and FIG. 15G and FIG. 15H are plan views for explaining a method for detecting displacement using the displacement detection device 10F according to the ninth embodiment. In the explanation of the displacement detection device 10F according to the ninth embodiment, differences from the displacement detection device 10 will mainly be explained using FIG. 15A to FIG. 15H. In the description of the ninth embodiment, the description that is the same as or similar to the description of FIG. 1A to FIG. 14H may be omitted.

### 9-1. Configuration of Displacement Detection Device 10F

As shown in FIG. 15A and FIG. 15B, the displacement detection device 10F includes the first fixed member 16C, the bearing 164, the rotating member 14F, and a detection device 18F. In the displacement detection device 10F shown in FIG. 15A and FIG. 15B, part of the coil spring 12, the second fixed member 20, and the damper 22 are omitted. The bearing 164, the coil spring 12, and the second fixed member 20 are the same as the bearing 164, the coil spring 12, and the second fixed member 20 of the first embodiment, and the first fixed member 16C is the same as the first fixed member 16C of the sixth embodiment. Therefore, the explanation of the first fixed member 16C, the bearing 164, the coil spring 12, and the second fixed member 20 in the ninth embodiment will be omitted. Similar to the displacement detection device 10, in the displacement detection device 10F, for convenience, a side on which the rotating member 14F is arranged with respect to the coil spring 12 is referred to as “upper”, and a side on which the second fixed member 20 is arranged is referred to as “lower”.

In the displacement detection device 10F, the bearing 164 is arranged so as to be in contact with the inner wall 171 of the first fixed member 16C. In addition, the first fixed member 16C to which the bearing 164 is mounted is mounted such that the bearing 164 is in contact with the bearing mounting portion 148C of the rotating member 14F. In this case, the rotating member 14F is rotatably disposed with respect to the bearing 164. Further, the bearing 164 is sandwiched between the inner wall 171 and the bearing mounting portion 148C. The detection device 18F is mounted to a flange surface 162 of the first fixed member 16C. The first end turn portion 122 of the coil spring 12 is mounted so as to be in contact with the first coil spring mounting portion 144C of the rotating member 14F. The rotating member 14F and the second fixed member 20 are in contact with the coil spring 12. Further, the rod portion 228 of the damper 22 is inserted into the hollow portion 142C, and is fixed to the first fixed member 16C by using the nut 232.

### 9-2. Configuration of Detection Device 18F

The detection device 18F will be described with reference to FIG. 15A, FIG. 15B, FIG. 15C or FIG. 15D. The detection device 18F includes a slide pin 185. The detection device 18F is a so-called slide volume. Resistivity of the detection device 18F can be changed by sliding a position of the slide pin 185. It is possible to convert an amount of rotation associated with the rotation of the rotating member 14F into a linear displacement by using the detection device 18F.

### 9-3. Configuration of Rotating Member 14F

The rotating member 14F will be described with reference to FIG. 15A, FIG. 15B, FIG. 15E or FIG. 15F. The rotating member 14F differs from the rotating member 14C according to the sixth embodiment in that a long groove 147 is included in the first flange portion 146C. In the rotating member 14F, other configurations and functions are the same as the configurations and functions of the rotating member 14C, and therefore, explanation thereof will be omitted. The slide pin 185 is inserted into the long groove 147, and the long groove 147 can absorb radial displacement of the slide pin 185 caused by the rotation of the rotating member 14F.

9-4. Method for Detecting Displacement using Displacement Detection Device 10F

An example of a method for detecting displacement using the displacement detection device 10F will be described with reference to FIG. 15G or FIG. 15H. As shown in FIG. 15G, in a plan view of the displacement detection device 10F, the first fixed member 16C and the rotating member 14F overlap each other, and the slide pin 185 of the detection device 18F disposed on the first fixed member 16C is inserted into the long groove 147 arranged on the rotating member 14F. The coil spring 12 is deformed, the rotating member 14F is rotated, and a state of the displacement detection device 10F is changed from a state shown in FIG. 15G to a state shown in FIG. 15H. For example, if the rotating member 14F is rotated by an angle α, the long groove 147 is also rotated by the angle α. With the rotation of the long groove 147, the position of the slide pin 185 inserted into the long groove 175 also changes to a position of a slide pin 185′, so that in the displacement detection device 10F according to the ninth embodiment, the rotation angle α (amount of rotation) can be converted into a linear displacement from the position of the slide pin 185 to the position of the slide pin 185′.

### 10. Tenth Embodiment

In a tenth embodiment, an example of an arrangement of a detection device in a displacement detection device will be described. A displacement detection device 10G according to the tenth embodiment mainly differs from the displacement detection device 10 in an arrangement of a detection device, a fixed member, a bearing, and a rotating member. Other configurations are the same as configurations of the displacement detection device 10.

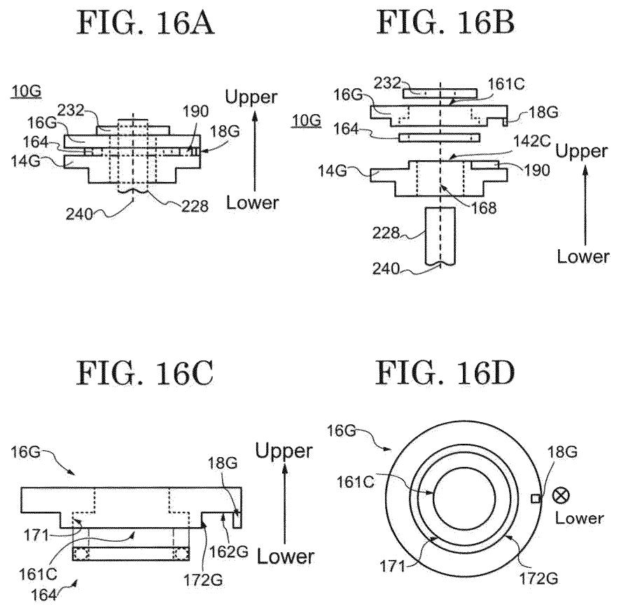

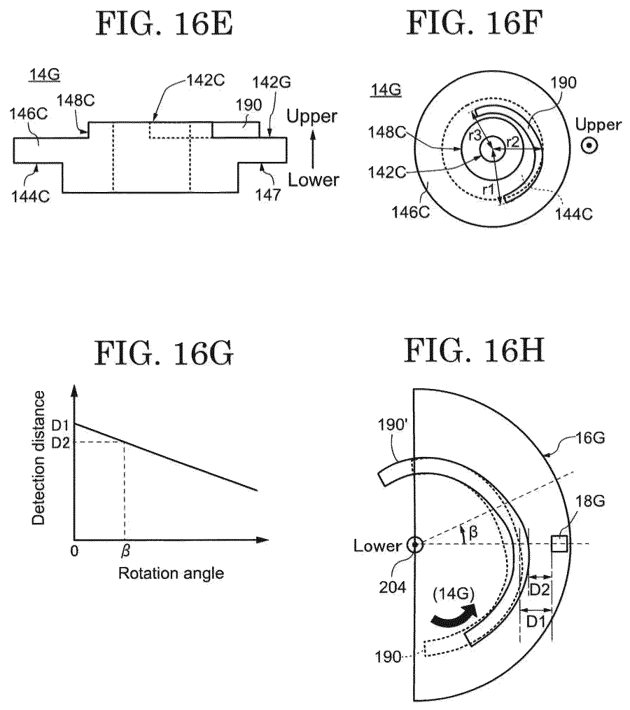

FIG. 16A is a schematic side view of the displacement detection device 10G, and FIG. 16B is a side view in which the displacement detection device 10G is deployed into respective elements. FIG. 16C to FIG. 16F are enlarged views of the elements shown in the FIG. 16A and FIG. 16B. FIG. 16C and FIG. 16D are diagrams showing a first fixed member 16G, the bearing 164, and a detection device 18G, FIG. 16E and FIG. 16F are diagrams showing a rotating member 14G, FIG. 16G and FIG. 16H are a graph and a schematic diagram showing the displacement detection device 10G according to the tenth embodiment. In the explanation of the displacement detection device 10G according to the tenth embodiment, differences from the displacement detection device 10 will mainly be explained using FIG. 16A to FIG. 16H. In the description of the tenth embodiment, description that is the same as or similar to the description in FIG. 1A to FIG. 15H may be omitted.

### 10-1. Configuration of Displacement Detection Device 10G

As shown in FIG. 16A and FIG. 16B, the displacement detection device 10G includes the first fixed member 16G, the bearing 164, the rotating member 14G, and the detection device 18G. In the displacement detection device 10G shown in FIG. 16A and FIG. 16B, part of the coil spring 12, the second fixed member 20, and the damper 22 are omitted. The bearing 164, the coil spring 12, and the second fixed member 20 are the same as the bearing 164, the coil spring 12, and the second fixed member 20 in the first embodiment, and the description of the bearing 164, the coil spring 12, and the second fixed member 20 in the tenth embodiment is omitted. Similar to the displacement detection device 10, in the displacement detection device 10G, for convenience, a side on which the rotating member 14G is arranged with respect to the coil spring 12 is referred to as “upper”, and a side on which the second fixed member 20 is arranged is referred to as “lower”.

In the displacement detection device 10G, the bearing 164 is arranged so as to be in contact with the inner wall 171 of the first fixed member 16G. In addition, the first fixed member 16G to which the bearing 164 is mounted is mounted such that the bearing 164 is in contact with the bearing mounting portion 148C of the rotating member 14G. In this case, the rotating member 14G is rotatably disposed with respect to the bearing 164. In addition, the bearing 164 is sandwiched between the inner wall 171 and the bearing mounting portion 148C. The detection device 18G is mounted to a flange surface 162G of the first fixed member 16G. The first end turn portion 122 of the coil spring 12 is mounted so as to be in contact with the first coil spring mounting portion 144C of the rotating member 14G. The rotating member 14G and the second fixed member 20 are in contact with the coil spring 12. Further, the rod portion 228 of the damper 22 is inserted into the hollow portion 142C, and is fixed to the first fixed member 16G by using the nut 232.

### 10-2. Configuration of First Fixed Member 16G and Detection Device 18G

The first fixed member 16G and the detection device 18G will be described with reference to FIG. 16A, FIG. 16B, FIG. 16C or FIG. 16D. Since configurations and functions of the first fixed member 16G are the same as the configurations and functions of the first fixed member 16C, the explanation thereof will be omitted. As shown in FIG. 16C and FIG. 16D, the detection device 18G is arranged on the flange surface 162G of the first fixed member 16G. The detection device 18G includes a laser oscillator (not shown) similar to the detection device 18E according to the eighth embodiment.

### 10-3. Configuration of Rotating Member 14G

The rotating member 14G will be described with reference to FIG. 16A, FIG. 16B, FIG. 16E or FIG. 16F. The rotating member 14G differs from the rotating member 14C according to the sixth embodiment in that it includes an arc-shaped convex portion 190. In the rotating member 14G, other configurations and functions are the same as the configurations and functions of the rotating member 14C, and therefore, explanation thereof will be omitted. As shown in FIG. 16E or FIG. 16F, the arc-shaped convex portion 190 is a convex member arranged on a flange surface 142G. As shown in FIG. 16F, in a plan view, the arc-shaped convex portion 190 is an arc shape in which a length from the center of the rotating member 14G gradually decreases, for example, a length r1, a length r2, and a length r3. Further, in the case where the first fixed member 16G and the rotating member 14G are combined, the arc-shaped convex portion 190 is disposed between an outer wall 172G and the detection device 18G. In addition, the arc-shaped convex portion 190 may be referred to as a curved member.

10-4. Method for Detecting Displacement using Displacement Detection Device 10G

An example of a method for detecting displacement using the displacement detection device 10G will be described with reference to FIG. 16G or FIG. 16H. FIG. 16G is a diagram showing a relationship between a distance between the displacement detection device 10G and an arc-shaped convex portion 190 (detection distance) and a rotation angle of the rotating member 14G. As shown in FIG. 16G, in the tenth embodiment, a relationship between a detection distance and a rotation angle is linear, and as an example, the detection distance becomes shorter as the rotation angle becomes larger. In the relationship between the detection distance and the rotation angle, the detection distance may become longer as the rotation angle becomes smaller.

The arc-shaped convex portion 190 is in fact arranged between the first fixed member 16G and the rotating member 14G and is not visible in a plan view. However, in order to facilitate understanding of the detecting method, in FIG. 16H, a position of the arc-shaped convex portion 190 in an initial state prior to the rotation of the rotating member 14G is indicated by a dotted line, and a position of an arc-shaped convex portion 190′ when the rotating member 14G is rotated in a direction of a black arrow is indicated by a solid line. Further, a laser beam irradiated by the detection device 18G is reflected by the arc-shaped convex portion 190, and the detection device 18G is capable of detecting the reflected laser beam.

In the initial state prior to the rotation of the rotating member 14G, the detected distance is, for example, a distance D1. When the coil spring 12 is deformed and, for example, the rotational member 14G rotates by an angle β, the position of the arc-shaped convex portion 190 changes from the position of the arc-shaped convex portion 190 indicated by the dotted line to the position of the arc-shaped convex portion 190′ indicated by the solid line. In a state in which the rotational member 14G rotates by the angle β, the detection device 18G detects a distance D2. In the displacement detection device 10G according to the tenth embodiment, the rotational angle β (rotational amount) can be converted into a linear displacement from the position of the arc-shaped convex portion 190 to the position of the arc-shaped convex portion 190′ (difference between the distance D1 and the distance D2) by using the detection device 18G.

### 11. Eleventh Embodiment

In an eleventh embodiment, an example of an arrangement of a detection device in a displacement detection device will be described. A displacement detection device 10H according to the eleventh embodiment mainly differs from the displacement detection device 10 in an arrangement of a detection device, a fixed member, a bearing, and a rotating member. Other configurations are the same as the configurations of the displacement detection device 10.

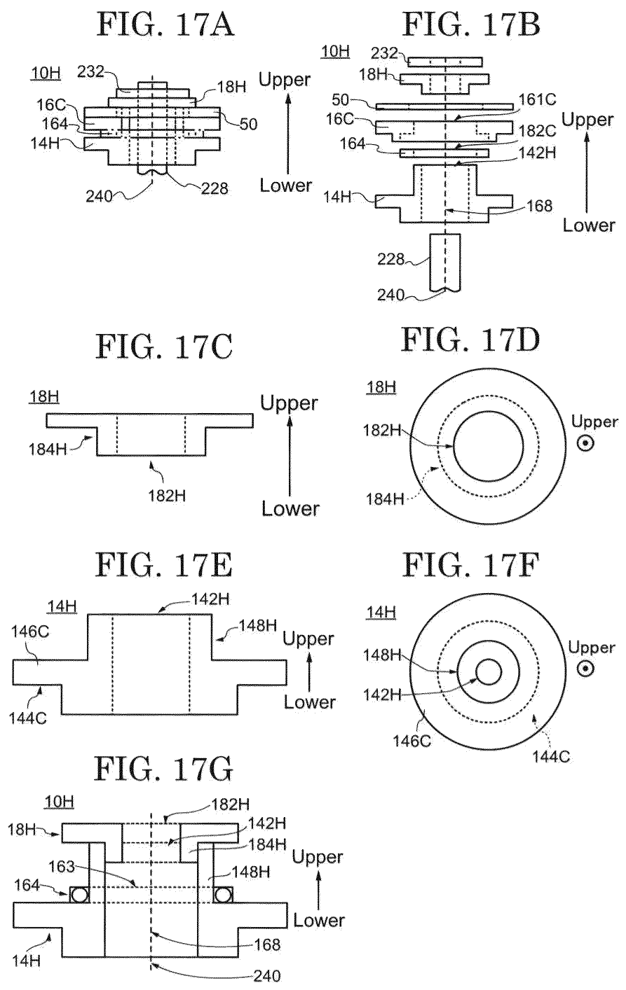

FIG. 17A is a schematic side view of the displacement detection device 10H, and FIG. 17B is a side view in which the displacement detection device 10H is deployed into respective elements. FIG. 17C to FIG. 17G are enlarged views of the elements shown in FIG. 17A and FIG. 17B. FIG. 17C and FIG. 17D are diagrams showing a detection device 18H, FIG. 17E and FIG. 17F are diagrams showing a rotating member 14H, and FIG. 17G is a diagram showing a cross-sectional view of the detection device 18H, the bearing 164, and the rotating member 14H of the displacement detection device 10H according to the eleventh embodiment. In the explanation of the displacement detection device 10H according to the eleventh embodiment, differences from the displacement detection device 10 will mainly be explained using FIG. 17A to FIG. 17G. In the description of the eleventh embodiment, the description that is the same as or similar to the description of FIG. 1A to FIG. 16H may be omitted.

### 11-1. Configuration of Displacement Detection Device 10H

As shown in FIG. 17A and FIG. 17B, the displacement detection device 10H includes the first fixed member 16C, the bearing 164, the rotating member 14H, and the detection device 18H. In addition, in the displacement detection device 10H shown in FIG. 17A and FIG. 17B, a part of the coil spring 12, the second fixed member 20, and the damper 22 are omitted. The bearing 164, the coil spring 12, and the second fixed member 20 are the same as the bearing 164, the coil spring 12, and the second fixed member 20 of the first embodiment, and the first fixed member 16C is the same as the first fixed member 16C of the sixth embodiment. Therefore, the explanation of the first fixed member 16C, the bearing 164, the coil spring 12, and the second fixed member 20 in the eleventh embodiment will be omitted. Similar to the displacement detection device 10, in the displacement detection device 10H, for convenience, a side on which the rotating member 14H is arranged with respect to the coil spring 12 is referred to as “upper”, and a side on which the second fixed member 20 is arranged is referred to as “lower”.

In the displacement detection device 10H, the first fixed member 16C is mounted to the vehicle body 50 using, for example, the bolt 234 (see FIG. 10). The detection device 18H is disposed so as to be in contact with a side opposite to a side where the first fixed member 16C is disposed with respect to the vehicle body 50. The detection device 18H is mounted using bolts (not shown) in the same manner as the first fixed member 16C. The bearing 164 is disposed in contact with the inner wall 171 of the first fixed member 16C. In addition, the first fixed member 16C to which the bearing 164 is mounted is mounted such that the bearing 164 is in contact with a bearing mounting portion 148H of the rotating member 14H. In this case, the rotating member 14H is rotatably disposed with respect to the bearing 164. In addition, the bearing 164 is sandwiched between the inner wall 171 and the bearing mounting portion 148H. The first end turn portion 122 of the coil spring 12 is mounted so as to be in contact with the first coil spring mounting portion 144C of the rotating member 14H. The rotating member 14H and the second fixed member 20 are in contact with the coil spring 12. Further, the rod portion 228 of the damper 22 is inserted into a hollow portion 142H and a hollow portion 182H, and are fixed to the detection device 18H by using the nuts 232.

### 11-2. Configuration of Detection Device 18H

The detection device 18H will be described with reference to FIG. 17A, FIG. 17B, FIG. 17C or FIG. 17D. The detection device 18H includes a rotating member mounting portion 184H and the hollow portion 182H. As shown in FIG. 17D, in a plan view, the rotating member mounting portion 184H is disposed inside an outer edge, and the hollow portion 182H is disposed inside the rotating member mounting portion 184H.

### 11-3. Configuration of Rotating Member 14H

The rotating member 14H will be described with reference to FIG. 17A, FIG. 17B, FIG. 17E or FIG. 17F. The rotating member 14H differs from the rotating member 14C according to the sixth embodiment in that the bearing mounting portion 148H and the hollow portion 142H extend upward. In the rotating member 14H, other configurations and functions are the same as the configurations and functions of the rotating member 14C, and therefore, explanation thereof will be omitted.

### 11-4. Cross-sectional View of Detection Device 18H, Bearing 164, and Rotating Member 14H

A cross-sectional view of the detection device 18H, the bearing 164, and the rotating member 14H will be described with reference to FIG. 17G. The bearing 164 is disposed so as to be in contact with the bearing mounting portion 148H. The rotating member 14H is inserted into the rotating member mounting portion 184H of the detection device 18H in the hollow portion 142H. The rotating member mounting portion 184H is in contact with the hollow portion 142H, and the detection device 18H is in contact with a portion of the rotating member 14H. Thus, the detection device 18H supports the rotating member 14H.

### 12. Twelfth Embodiment

In a twelfth embodiment, an example of an arrangement of a detection device in a displacement detection device will be described. A displacement detection device 10J according to the twelfth embodiment mainly differs from the displacement detection device 10 in an arrangement of a detection device, a fixed member, a bearing, and a rotating member. Other configurations are the same as the configurations of the displacement detection device 10.

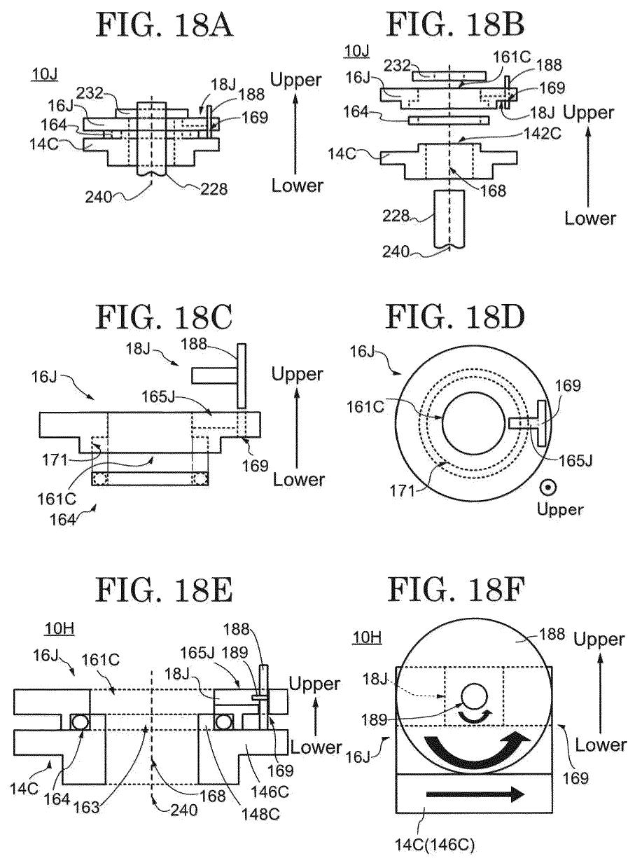

FIG. 18A is a schematic side view of the displacement detection device 10J, and FIG. 18B is a side view in which the displacement detection device 10J is deployed into respective elements. FIG. 18C to FIG. 18F are enlarged views of the elements shown in FIG. 18A and FIG. 18B. FIG. 18C is a diagram showing a first fixed member 16J, the bearing 164, and a detection device 18J, FIG. 18D is a diagram showing the first fixed member 16J, FIG. 18E is a cross-sectional view of the detection device 18J, the first fixed member 16J, the bearing 164, and the rotating member 14C, FIG. 18F is a side view for explaining a method for detecting displacement using the displacement detection device 10J. In the explanation of the displacement detection device 10J according to the twelfth embodiment, differences from the displacement detection device 10 will mainly be explained using FIG. 18A to FIG. 18F. In the description of the twelfth embodiment, the description that is the same as or similar to the description of FIG. 1A to FIG. 17G may be omitted.

### 12-1. Configuration of Displacement Detection Device 10J

As shown in FIG. 18A and FIG. 18B, the displacement detection device 10J includes the first fixed member 16J, the bearing 164, the rotating member 14C, and the detection device 18J. In the displacement detection device 10J shown in FIG. 18A and FIG. 18B, part of the coil spring 12, the second fixed member 20, and the damper 22 are omitted. The bearing 164, the coil spring 12, and the second fixed member 20 are the same as the bearing 164, the coil spring 12, and the second fixed member 20 of the first embodiment, and the rotating member 14C is the same as the rotating member 14C of the sixth embodiment. Therefore, explanation of the rotating member 14C, the bearing 164, the coil spring 12, and the second fixed member 20 in the twelfth embodiment will be omitted. Similar to the displacement detection device 10, in the displacement detection device 10J, for convenience, a side on which the rotating member 14C is arranged with respect to the coil spring 12 is referred to as “upper”, and a side on which the second fixed member 20 is arranged is referred to as “lower”.

In the displacement detection device 10J, the bearing 164 is arranged so as to be in contact with the inner wall 171 of the first fixed member 16J. In addition, the first fixed member 16J to which the bearing 164 is mounted is mounted such that the bearing 164 is in contact with the bearing mounting portion 148C of the rotating member 14C. In this case, the rotating member 14C is rotatably disposed with respect to the bearing 164. In addition, the bearing 164 is sandwiched between the inner wall 171 and the bearing mounting portion 148C. The first end turn portion 122 of the coil spring 12 is mounted so as to be in contact with the first coil spring mounting portion 144C of the rotating member 14C. The rotating member 14C and the second fixed member 20 are in contact with the coil spring 12. Further, the rod portion 228 of the damper 22 is inserted into the hollow portion 142C and the stepped hollow portion 161C, and is fixed to the first fixed member 16J by using the nut 232.

### 12-2. Configuration of First Fixed Member 16J

The first fixed member 16J will be described with reference to FIG. 18A, FIG. 18B, FIG. 18C or FIG. 18D. The first fixed member 16J differs from the first fixed member 16C in that the first fixed member 16J includes a detection device mounting portion 165J and a roller groove 169. In the first fixed member 16J, other configurations and functions are the same as the configurations and functions of the first fixed member 16C, and therefore, explanation thereof will be omitted. As shown in FIG. 18D, in a plan view, the detection device mounting portion 165J is rectangular and is in contact with the roller groove 169 that is rectangular. The roller groove 169 is arranged so as to penetrate part of a periphery of the first fixed member 16J.

### 12-3. Configuration of Detection Device 18J

The detection device 18J will be described with reference to FIG. 18A, FIG. 18B, FIG. 18E or FIG. 18F. The detection device 18J includes a roller 188 and a shaft 189. The detection device 18J is mounted to the detection device mounting portion 165J such that a portion of the roller 188 protrudes from the roller groove 169.

### 12-4. Sectional View of Detection Device 18J, First Fixed Member 16J, Bearing 164, and Rotating Member 14C

A cross-sectional view of the detection device 18J, the first fixed member 16J, the bearing 164, and the rotating member 14C will be described with reference to FIG. 18E. The bearing 164 is disposed so as to be in contact with the bearing mounting portion 148C. The detection device 18J is arranged such that a portion of the roller 188 protrudes from the roller groove 169 and comes into contact with an upper surface of the first flange portion 146C. The roller 188 is mounted with the shaft 189. In addition, although not shown, the shaft 189 is rotatably inserted into a bearing inside the detection device 18J.

12-5. Method for Detecting Displacement using Displacement Detection Device 10J

A method for detecting displacement using the detection device 18J will be described with reference to FIG. 18F. When the coil spring 12 deforms and the rotating member 14C (first flange portion 146C) rotates in a direction of a black arrow, the roller 188 rotates in a direction of an arc-shaped black arrow about the shaft 189. The detection device 18J can detect an amount of rotation of the roller 188.

### 13. Thirteenth Embodiment

In a thirteenth embodiment, an example of an arrangement of a detection device in a displacement detection device will be described. A displacement detection device 10K according to the thirteenth embodiment differs from the displacement detection device 10D according to the seventh embodiment in that the displacement detection device 10K includes a detection device including a Hall IC and a magnet 170. The other configurations are the same as the configurations of the displacement detection device 10D, and therefore, differences from the displacement detection device 10D are mainly described here.

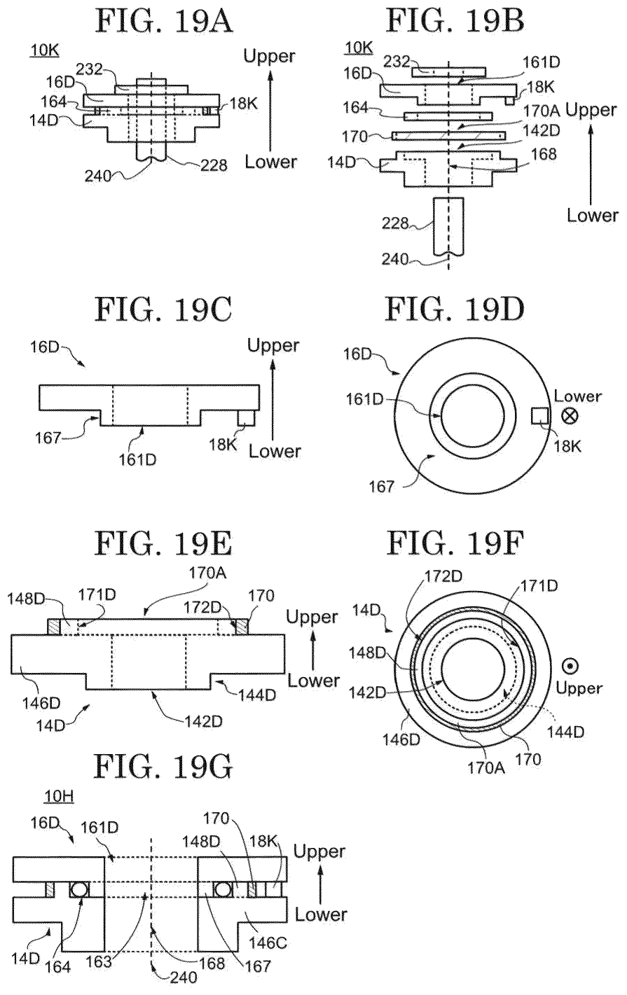

FIG. 19A is a schematic side view of the displacement detection device 10K, and FIG. 19B is a side view in which the displacement detection device 10K is deployed into respective elements. FIG. 19C to FIG. 19G are enlarged views of the elements shown in the FIG. 19A and FIG. 19B. FIG. 19C and FIG. 19D are diagrams showing the first fixed member 16D and a detection device 18K, FIG. 19E and FIG. 19F are diagrams showing the rotating member 14D and the magnet 170, and FIG. 19G is a cross-sectional view of the first fixed member 16D, the detection device 18K, the bearing 164, the magnet 170 and the rotating member 14D of the displacement detection device 10K according to the thirteenth embodiment. In the description of the thirteenth embodiment, the description that is the same as or similar to the description of FIG. 1A to FIG. 18F may be omitted.

### 13-1. Configuration of Displacement Detection Device 10K

As shown in FIG. 19A and FIG. 19B, the displacement detection device 10K includes the first fixed member 16D, the bearing 164, the magnet 170, the rotating member 14D, and the detection device 18K. In addition, in the displacement detection device 10K shown in FIG. 19A and FIG. 19B, part of the coil spring 12, the second fixed member 20, and the damper 22 are omitted. In addition, the bearing 164, the coil spring 12, and the second fixed member 20 are the same as the bearing 164, the coil spring 12, and the second fixed member 20 of the first embodiment, and the first fixed member 16D and the rotating member 14D are the same as the first fixed member 16D and the rotating member 14D of the seventh embodiment. Therefore, the explanation of the first fixed member 16D, the bearing 164, the rotating member 14D, the coil spring 12, and the second fixed member 20 in the thirteenth embodiment will be omitted. Similar to the displacement detection device 10D, in the displacement detection device 10K, for convenience, a side on which the rotating member 14D is arranged with respect to the coil spring 12 is referred to as “upper”, and a side on which the second fixed member 20 is arranged is referred to as “lower”.

As shown in the FIG. 19C and FIG. 19D, the detection device 18K is disposed on the first fixed member 16D. As shown in FIG. 19F, the magnet 170 is ring-shaped. As shown in FIG. 19E, the magnet 170 is arranged so as to be in contact with the outer wall 172D.

### 13-2. Cross-Sectional Views of the Detection Device 18K, the Bearing 164, the Magnets 170, and the Rotating Member 14D

A cross-sectional view of the detection device 18K, the bearing 164, the magnets 170, and the rotating member 14D will be described with reference to FIG. 19G. The bearing 164 is disposed so as to be in contact between the bearing mounting portion 167 of the first fixed member 16D and the bearing mounting portion 148D of the rotating member 14D. The magnet 170 is arranged so as to be in contact with the outer wall 172D. The detection device 18K is arranged on an outer side of the magnet 170 (facing away from the hollow portion 163). In the displacement detection device 10K configured as described above, when the coil spring 12 is deformed and the rotating member 14D (the first flange portion 146D) rotates, magnetic flux of a portion where the detection device 18K is disposed changes. The detection device 18K can detect the change in magnetic flux using the Hall IC.

### 14. Fourteenth Embodiment

In a fourteenth embodiment, an example of an arrangement of a detection device in a displacement detection device will be described. A displacement detection device 10L according to the fourteenth embodiment differs from the displacement detection device 10E according to the eighth embodiment in configurations of a rotating member and a method for detecting displacement using the displacement detection device. Other configurations are the same as the configurations of the displacement detection device 10E.

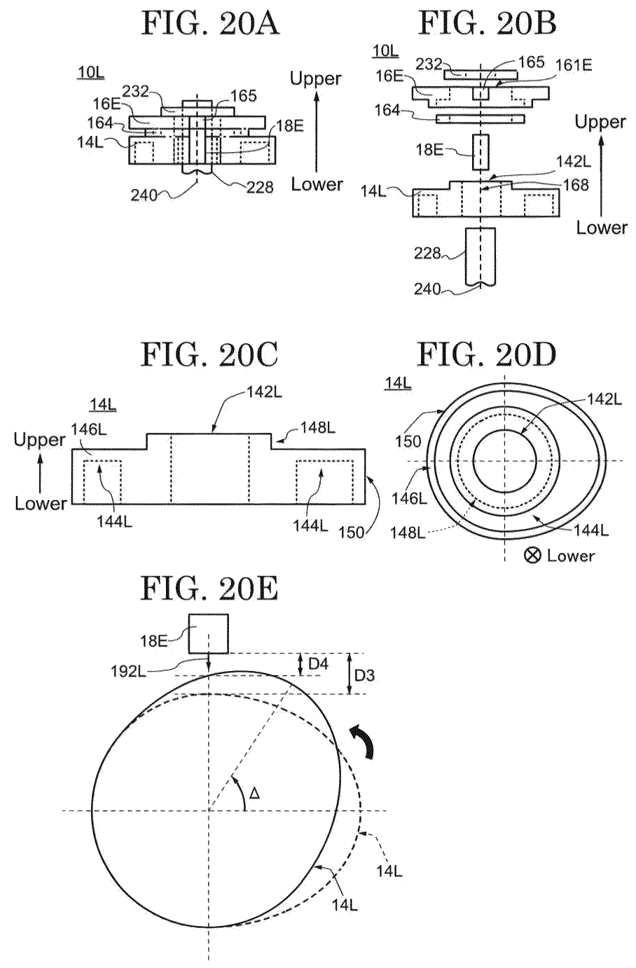

FIG. 20A is a schematic side view of the displacement detection device 10L, and FIG. 20B is a side view in which the displacement detection device 10L is deployed into respective elements. FIG. 20C and FIG. 20D are enlarged views of a rotating member 14L shown in FIG. 20A and FIG. 20B, and FIG. 20E is a schematic view for explaining a method for detecting displacement using the displacement detection device 10L. In the explanation of the displacement detection device 10L, differences from the displacement detection device 10E will mainly be explained using FIG. 20A to FIG. 20E. In the description of the fourteenth embodiment, the description that is the same as or similar to the description of FIG. 1A to FIG. 19G may be omitted.

### 14-1. Configuration of Displacement Detection Device 10L

As shown in FIG. 20A and FIG. 20B, the displacement detection device 10L includes the first fixed member 16E, the bearing 164, the rotating member 14L, and the detection device 18E. The configuration of the displacement detection device 10L is a configuration in which the rotating member 14E of the displacement detection device 10E is replaced with the rotating member 14L. In the configuration of the displacement detection device 10L, the same configuration as the configuration of the displacement detection device 10E will be omitted, and in the following, the rotating member 14L and the method for detecting displacement using the displacement detection device 10L will mainly be described.

### 14-2. Configuration of Rotating Member 14L

The rotating member 14L will be described with reference to FIG. 20A, FIG. 20B, FIG. 20C or FIG. 20D. FIG. 20C is a side view of the rotating member 14L, and FIG. 20D is a plan view of the rotating member 14L viewed from below. The rotating member 14L includes a first flange portion 146L, a bearing mounting portion 148L connected to the first flange portion 146L, and a hollow portion 142L. The first flange portion 146L includes a first coil spring mounting portion 144L. The first coil spring mounting portion 144L is disposed inside an outer periphery of the rotating member 14L, the bearing mounting portion 148L is disposed inside the first coil spring mounting portion 144L, and the hollow portion 142L is disposed inside the bearing mounting portion 148L. The first end turn portion 122 of the coil spring 12 is mounted to the first coil spring mounting portion 144L. Configurations and functions of the bearing mounting portion 148L and the hollow portion 142L are the same as the configurations and functions of the bearing mounting portion 148E and the hollow portion 142E, and therefore will not be described here. The rotating member 14L is a so-called cam. As shown in FIG. 20D, in a plan view, a shape of the rotating member 14L (a shape of an outer edge 150) is, for example, an oval shape. In addition, the shape of the rotating member 14L (the shape of the outer edge 150) is not limited to an oval shape, and may be any shape that functions as a cam.

14-3. Displacement Detection using Displacement Detection Device 10L

An example of the method for detecting displacement using the displacement detection device 10L will be described with reference to FIG. 20E. In order to facilitate understanding of the detection method, in FIG. 20E, a position of the rotating member 14L in an initial state prior to rotation is indicated by a dotted line, and a position of the rotating member 14L when the rotating member 14L is rotated in a direction of a black arrow is indicated by a solid line. The detection device 18E can detect a reflected laser beam by reflecting a laser beam 192L irradiated by the detection device 18E onto the outer edge 150 of the rotating member 14L.

In the initial state prior to the rotation of the rotating member 14L, a detected distance is, for example, a distance D3. When the coil spring 12 is deformed and, for example, the rotating member 14L is rotated by an angle A, a position of the rotating member 14L is from the position indicated by the dotted line to the position indicated by the solid line. When the rotating member 14L is rotated by the angle A, the detection device 18E detects a distance D4. In the displacement detection device 10L according to the fourteenth embodiment, the rotated angle A (amount of rotation) can be converted into a linear displacement (difference between the distance D3 and the distance D4) by using the detection device 18E.

### 15. Fifteenth Embodiment

In a fifteenth embodiment, an example of an arrangement of a detection device in a displacement detection device will be described. A displacement detection device 10M according to the fifteenth embodiment does not include the arc-shaped convex portion 190 and includes a convex portion 191 with respect to the displacement detection device 10G according to the tenth embodiment. In addition, in the displacement detection device 10M, an arrangement of the detection device 18G differs with respect to the displacement detection device 10G. Other configurations are the same as the configurations of the displacement detection device 10G.

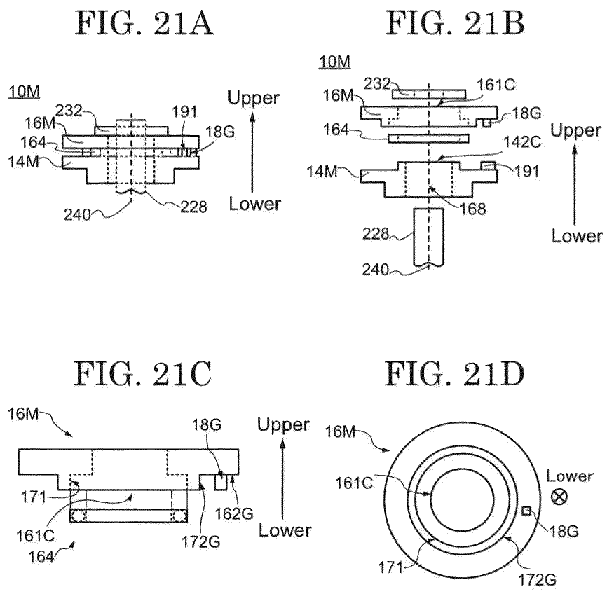

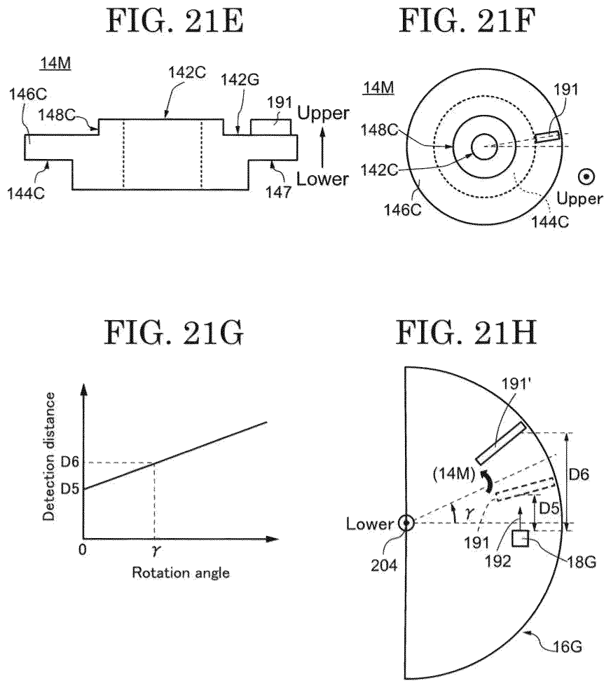

FIG. 21A is a schematic side view of the displacement detection device 10M, and FIG. 21B is a side view in which the displacement detection device 10M is deployed into respective elements. FIG. 21C to FIG. 21F are enlarged views of the elements shown in FIG. 21A and FIG. 21B. FIG. 21C and FIG. 21D are diagrams showing a first fixed member 16M, the bearing 164, and the detection device 18G, FIG. 21E and FIG. 21F are diagrams showing a rotating member 14M, and FIG. 21G and FIG. 21H are a diagram and a schematic diagram showing a method for detecting displacement using the displacement detection device 10M. In the explanation of the displacement detection device 10M, differences from the displacement detection device 10G will mainly be explained using FIG. 21A to FIG. 21H. In the description of the fifteenth embodiment, description that is the same as or similar to the description in FIG. 1A to FIG. 20E may be omitted.

### 15-1. Configuration of Displacement Detection Device 10M

As shown in FIG. 21A and FIG. 21B, the displacement detection device 10M includes the first fixed member 16M, the bearing 164, the rotating member 14M, and the detection device 18G. The configuration of the displacement detection device 10M is a configuration in which the first fixed member 16G and the rotating member 14G of the displacement detection device 10G are replaced with the first fixed member 16M and the rotating member 14M, respectively. In the configuration of the displacement detection device 10M, the same configuration as the configuration of the displacement detection device 10G will be omitted, and in the following, the first fixed member 16M, the rotating member 14M, and the method for detecting displacement using the displacement detection device 10M will mainly be described.

### 15-2. Configuration of First Fixed Member 16M and Detection Device 18G

The first fixed member 16M and the detection device 18G will be described with reference to FIG. 21A, FIG. 21B, FIG. 21C or FIG. 21D. Since the configuration and function of the first fixed member 16M are the same as the configuration and function of the first fixed member 16C, the explanation thereof will be omitted. The detection device 18G is arranged on the flange surface 162G of the first fixed member 16M. In the displacement detection device 10G, although the detection device 18G irradiates the arc-shaped convex portion 190 with a laser, in the displacement detection device 10M, the detection device 18G irradiates the convex portion 191 with a laser.

### 15-3. Configuration of Rotating Member 14M

The rotating member 14M will be described with reference to FIG. 21A, FIG. 21B, FIG. 21E or FIG. 21F. The configuration of the rotating member 14M is a configuration in which the arc-shaped convex portion 190 of the rotating member 14G is replaced with the convex portion 191. In the rotating member 14M, description of the same configuration and function as the configuration and function of the rotating member 14G is omitted, and in the following, the convex portion 191 is mainly described. As shown in FIG. 21E or FIG. 21F, the convex portion 191 is a convex member arranged on the flange surface 142G. As shown in FIG. 21F, in a plan view, the convex portion 191 is arranged in parallel in a radial direction so that, for example, the laser of the detection device 18G is irradiated. In addition, in the case where the first fixed member 16M and the rotating member 14M are combined, the convex portion 191 is arranged so as not to overlap the external wall 172G and the detection device 18G.

15-4. Method for Detecting Displacement using Displacement Detection Device 10M

An example of the method for detecting displacement using the displacement detection device 10M will be described with reference to FIG. 21G or FIG. 21H. FIG. 21G is a graph showing a relationship between a distance (detection distance) between the displacement detection device 10M and the convex portion 191 and a rotation angle of the rotating member 14M. As shown in FIG. 21G, in the fifteenth embodiment, the relationship between the detection distance and the rotation angle is linear, and as an example, the detection distance becomes longer as the rotation angle becomes larger.

The convex portion 191 is actually arranged between the first fixed member 16M and the rotating member 14M and is not visible in a plan view. However, in order to facilitate understanding of the detecting method, in FIG. 21H, a position of the convex portion 191 in an initial state prior to the rotation of the rotating member 14M is indicated by a dotted line, and a position of a convex portion 191′ when the rotating member 14M is rotated in a direction of a black arrow is indicated by a solid line. Further, a laser beam 192 irradiated by the detection device 18G is reflected by the convex portion 191, and the detection device 18G is capable of detecting the reflected laser beam.

In the initial state prior to the rotation of the rotating member 14M, the detected distance is, for example, a distance D5. When the coil spring 12 is deformed and, for example, the rotating member 14M rotates by an angle γ, the position of the convex portion 191 changes from the position of the convex portion 191 indicated by the dotted line to the position of the convex portion 191′ indicated by the solid line. When the rotating member 14M rotates by the angle γ, the detection device 18G detects a distance D6. In the displacement detection device 10M according to the fifteenth embodiment, the rotation angle γ (amount of rotation) can be converted into a linear displacement (difference between the distance D5 and the distance D6) from the position of the convex portion 191 to the position of the convex portion 191′ by using the detection device 18G.

The displacement detection device, the displacement detection system, the operation method of the displacement detection system, the industrial equipment, and the like described above as the embodiment of the present invention can be appropriately combined and implemented as long as they do not conflict with each other. Further, any addition, deletion or design modification of components by a person skilled in the art based on each embodiment will be included in the scope of the present invention as long as the gist of the present invention is provided.

In addition, it is understood that the present invention provides other operational effects that are different from the operational effects provided by the embodiments described above, as well as those that are obvious from the description of the present specification or those that can be easily predicted by a person skilled in the art.

What is claimed is:

1. A displacement detection device comprising:
a first fixed member;
a coil spring including a first end turn portion and a second end turn portion;
a rotating member in contact with the first end turn portion;
a second fixed member in contact with the second end turn portion; and
a detection device capable of detecting an amount of rotation of the coil spring.

2. The displacement detection device according to claim 1,
wherein the rotating member is rotatably supported using a bearing, and
the bearing is in contact with the first fixed member and the rotating member.

3. The displacement detection device according to claim 1,
wherein the detection device is disposed on a side opposite to a side on which the rotating member is disposed with respect to the first fixed member.

4. The displacement detection device according to claim 1,
wherein the detection device is disposed on the same side as a side on which the rotating member is disposed with respect to the first fixed member.

5. The displacement detection device according to claim 2,
wherein the detection device, the bearing, and the rotating member are integrated.

6. The displacement detection device according to claim 2, further comprising a damper having a third end and a fourth end,
wherein the third end is inserted into the first fixed member,
the fourth end is inserted into the second fixed member, and
a part of a periphery of the damper is fixed to the second fixed member.

7. The displacement detection device according to claim 6,
wherein the first fixed member and the second fixed member have members configured using one or more of metal, plastic, or an elastic member.

8. The displacement detection device according to claim 7,
wherein in the case where the first fixed member includes the elastic member, the detection device is covered by the elastic member.

9. A displacement detection system comprising:
the displacement detection device according to claim 1; and
an arithmetic circuit connected to the detection device and configured to be able to calculate a stroke of the coil spring using the amount of rotation.

10. The displacement detection system according to claim 9,
wherein the arithmetic circuit includes a memory circuit, and
the memory circuit includes a table in which the amount of rotation is linked with the stroke.

11. Industrial equipment comprising:
the displacement detection system according to claim 10;
a machine body in contact with the first fixed member; and
a wheel in contact with the second fixed member.

12. The industrial equipment according to claim 11,
wherein the industrial equipment is a vehicle, and
the machine body is a car body.
